(19) United States
(12) Patent Application Publication
(10) Pub. No.: US 2016/0101499 A1
(43) Pub. Date: Apr. 14, 2016

(54) TECHNIQUES FOR FORMING RECESS IN SUBSTRATE AND ARTICLES INCLUDING RECESSES

(71) Applicant: 3M INNOVATIVE PROPERTIES COMPANY, St. Paul, MN (US)

(72) Inventors: Bruce A Sventek, Woodbury, MN (US); Kathryn R. Bretscher, Minnetonka, MN (US); David G Baird, Woodbury, MN (US); Lee A Fain, Huntersville, NC (US); Mitchell L Nelson, Minneapolis, MN (US)

(21) Appl. No.: 14/895,029

(22) PCT Filed: May 28, 2014
(86) PCT No.: PCT/US2014/039691

§ 371 Date: Dec. 1, 2015

Related U.S. Application Data
(60) Provisional application No. 61/832,330, filed on Jun. 7, 2013.

(51) Int. Cl. B24B 37/24; B32B 9/04; B32B 17/06; B32B 3/30; B32B 3/02

(52) U.S. Cl. CPC B24B 37/24; B32B 3/30; B32B 3/02; B32B 17/06; B32B 9/04; B32B 2457/00

(57) ABSTRACT

An assembly may include a substrate defining at least one recess and a component located adjacent to the recess and attached to the substrate. In some examples, the recess may be formed by frictionally contacting a structured abrasive layer of an abrasive article with a surface of the substrate, longitudinally advancing the structured abrasive layer relative to the surface of the substrate, and rotating the substrate around a rotational axis substantially perpendicular to the surface of the substrate such that the structured abrasive layer maintains contact with and abrades the surface of the substrate thereby forming the recess therein. In some examples, the recess may be formed in the substrate after the component is attached to the substrate. Moreover, the recess may be formed without using added loose abrasive particles or abrasive slurry.

### CROSS REFERENCE TO RELATED APPLICATION

This application claims priority to U.S. Provisional Patent Application No. 61/832,330, filed Jun. 7, 2013, which is incorporated herein by reference in its entirety.

### TECHNICAL FIELD

The present disclosure relates to methods and materials for forming recesses in a substrate, and articles made therefrom.

### BACKGROUND

Forming recesses in planar substrates has been carried out by etching processes, molding processes, and polishing methods using abrasive slurries.

U. S. Patent Application Publication No. 2012/0270016 A1 (Hashimoto et al.) describes a cover glass for use in a mobile device such as a touch-panel mobile telephone that has a recess that can be recognized as a character or a figure when watching from the front side of the mobile device or a recess that can be recognized when touching from the front side of the mobile device is formed on at least one of opposite main surfaces of the cover glass. A surface of this recess results from a chemical etching process. Such methods can involve hazardous chemicals, be difficult to control, and/or may alter the surface roughness or the chemical composition of the cover glass.

U. S. Patent Application Publication No. 2012/0287057 A1 (Wei) describes an integrated glass including a solid sculpted area with a number of concave shapes or convex shapes which can be used to form letters, numbers or patterns for user decorating or identifying. The shapes are formed by a process wherein a heated glass preform is pressed against a mold. This energy intensive process involves specialized equipment (e.g., an oven for heating the glass preform), and may not be well-suited for low volume or custom applications where mold fabrication costs may make it uneconomical.

Various dimpling grinders (e.g., a Model 200 Dimpling grinder marketed by E. A. Fischione Instruments, Inc.) have been commercially available. The devices are typically used for the preparation of high quality specimens for transmission electron microscopy (TEM) and as a test for evaluating the wear of coatings. The devices include a vertically oriented rotating wheel that contacts a horizontally rotating stage with the substrate mounted thereto. The wheel itself (which may be, for example, stainless steel, micarta, or wood) does not contain abrasive particles, but is used in combination with a slurry containing abrasive particles in a liquid vehicle. This process is relatively slow, messy, wasteful of abrasive particles, and can lead to distortions in the recess shape, poorer finish and lack of reproducibility.

### SUMMARY

The present disclosure describes technique for forming recesses in a substrate and articles and assemblies including substrates with recesses formed therein. In some examples, the recesses may be formed in a substrate that is attached to a component, such as an electronic component. In other examples, the recesses may be formed in a substrate that includes at least one modified surface layer, e.g., a coating or a region within the substrate that has been chemically modified. In some examples, the recess may include a substantially constant radius of curvature for at least about 98% of the depth of the recess (where the depth of the recess is measured from the lowest point of the recess to a the plane of the surface of the substrate in which the recess is formed, and is in a direction substantially normal to the plane of the surface of the substrate).

In one example, the disclosure describes a method including forming an assembly comprising a substrate and component attached to a first surface of the substrate, where the substrate further comprises a second surface substantially opposite to the first surface. The method also may include frictionally contacting a structured abrasive layer of an abrasive article with the second surface of the substrate. The abrasive article may include a structured abrasive member disposed along a peripheral surface of a support member, and the structured abrasive member comprises the structured abrasive layer comprising shaped abrasive composites secured to a backing. The backing may be proximate to the support member, and the shaped abrasive composites comprise abrasive particles retained in a binder material. The method further may include longitudinally advancing the structured abrasive layer relative to the second surface of the substrate, and rotating the substrate around a rotational axis perpendicular to the second surface of the substrate such that the structured abrasive layer maintains contact with and abrades the second surface of the substrate thereby forming a recess therein.

In another example, the disclosure describes a method including forming a treated substrate comprising a modified surface, and frictionally contacting a structured abrasive layer of an abrasive article with the modified surface of the substrate. The abrasive article may include a structured abrasive member disposed along a peripheral surface of a support member, and the structured abrasive member comprises the structured abrasive layer comprising shaped abrasive composites secured to a backing. The backing may be proximate to the support member, and the shaped abrasive composites comprise abrasive particles retained in a binder material. The method further may include longitudinally advancing the structured abrasive layer relative to the modified surface of the substrate, and rotating the substrate around a rotational axis perpendicular to the modified surface of the substrate such that the structured abrasive layer maintains contact with and abrades the modified surface of the substrate thereby forming a recess therein.

In a further example, the disclosure describes an article including a substrate comprising a surface defining a recess. In some examples, the recess has a substantially consistent radius of curvature in at least one plane substantially perpendicular to the surface for at least about 98% of a depth of the recess, and the depth of the recess is measured from the plane of the surface to a point of the recess furthest from the surface in a direction substantially normal to the plane of the surface.

In an additional example, the disclosure describes an assembly that includes a substrate comprising a recess and a component located adjacent to the recess and attached to the substrate. The recess is formed by frictionally contacting a structured abrasive layer of an abrasive article with a surface of the substrate, longitudinally advancing the structured abrasive layer relative to the surface of the substrate, and rotating the substrate around a rotational axis perpendicular to the surface of the substrate such that the structured abrasive layer maintains contact with and abrades the surface of the substrate thereby forming the recess therein. The abrasive article may include a structured abrasive member disposed along a peripheral surface of a support member, and the structured abrasive member comprises the structured abrasive layer comprising shaped abrasive composites secured to a backing. The backing may be proximate to the support member, and the shaped abrasive composites comprise abrasive particles retained in a binder material.

As used herein,

“abrasive composite” refers to a mixture of abrasive particles retained in an organic binder material (typically a crosslinked polymeric material);

“display cover” refers to any transparent material (e.g., glass or sapphire) that is adapted for use as a cover of an electronic display;

“dimple” refers to a recess formed in a surface, wherein the recess has a surface corresponding to a partial surface of a sphere;

“frictionally contacting” means urging into contact with sufficient force that frictional force (e.g., as manifested by a static and/or kinetic coefficient of friction) is established;

“longitudinally advancing” means moving along the direction of travel of the outermost abrasive surface of an abrasive wheel or belt as it abrades a substrate during ordinary use;

“shaped abrasive composite” refers to an abrasive composite that has a predetermined shape that is replicated from a mold cavity used to form the shaped abrasive composite;

“spherically concave surface” means a concavely curved surface in the form of a portion of a sphere; and

“edge roll off” refers to curvature between the surface of the substrate in which the recess is formed and the surface of the recess.

Features and advantages of the present disclosure will be further understood upon consideration of the detailed description as well as the appended claims.

### BRIEF DESCRIPTION OF DRAWINGS

FIG. 1 is a schematic side view of an exemplary configuration for practicing one method according to the present disclosure.

FIG. 1A is an enlarged schematic top view of the region 1A shown in FIG. 1.

FIG. 2 is a schematic perspective view of a structured abrasive wheel suitable for practicing the present disclosure.

FIG. 2A is an enlarged schematic top view of a portion of abrasive wheel 130 in FIG. 2.

FIG. 3 is a schematic side view of an exemplary cover according to the present disclosure.

FIG. 4 is a schematic side view of another exemplary cover according to the present disclosure.

FIG. 5 is a conceptual and schematic diagram of an example display assembly.

FIG. 6 is a conceptual and schematic diagram of another example assembly including a glass cover.

FIG. 7 is a conceptual and schematic diagram of another example assembly including a glass cover.

FIG. 8 is a conceptual and schematic diagram illustrating an example substrate including a dimple formed in a first surface of the substrate, and a component disposed at least partially within the volume defined by the dimple.

FIG. 9 is a conceptual and schematic diagram illustrating an example assembly including a substrate, a dimple, and a component located adjacent to an opposite surface from the dimple.

FIG. 10 is a conceptual and schematic diagram illustrating example assembly that includes a dimple formed in a first surface of a substrate, and a component located adjacent to a second surface of the substrate.

FIG. 11 is a conceptual and schematic diagram illustrating an example assembly that includes a first dimple formed in a first surface of a substrate, and a second dimple formed in a second surface of substrate with a reservoir for fluid, gas or polymer.

FIGS. 12A and 12B are conceptual and schematic diagrams illustrating an example substrate including a depressed ring having a surface shaped as a section of a torus.

FIGS. 13-15 are conceptual and schematic diagrams that illustrate example arrays of dimples formed in a substrate.

FIG. 16 is a conceptual and schematic diagram that illustrates an example cover sheet with a four recesses formed therein.

FIG. 17 is a conceptual and schematic diagram that illustrates an example portion of a housing that includes a plurality of recesses that may function as grip aids or positioning aids for a user when interacting with an electronic device.

FIG. 18 is a surface profile of a dimple generated according to Example 2.

FIG. 19 is a surface profile of a dimple generated according to Comparative Example A.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

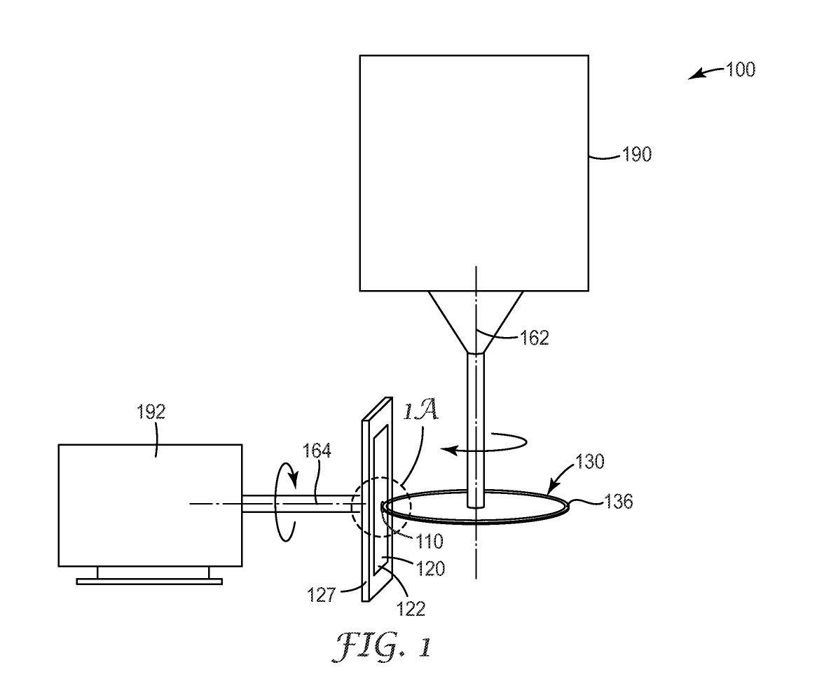

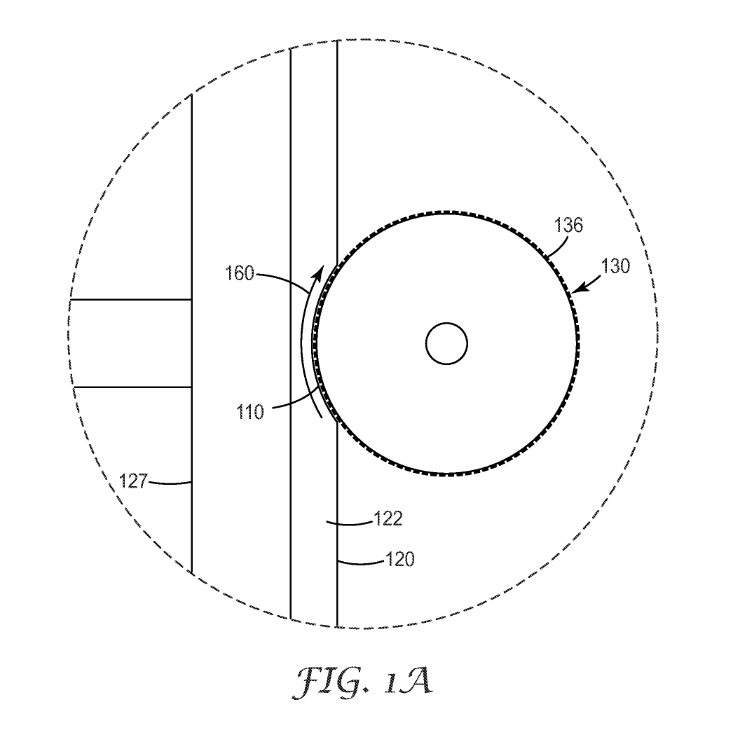

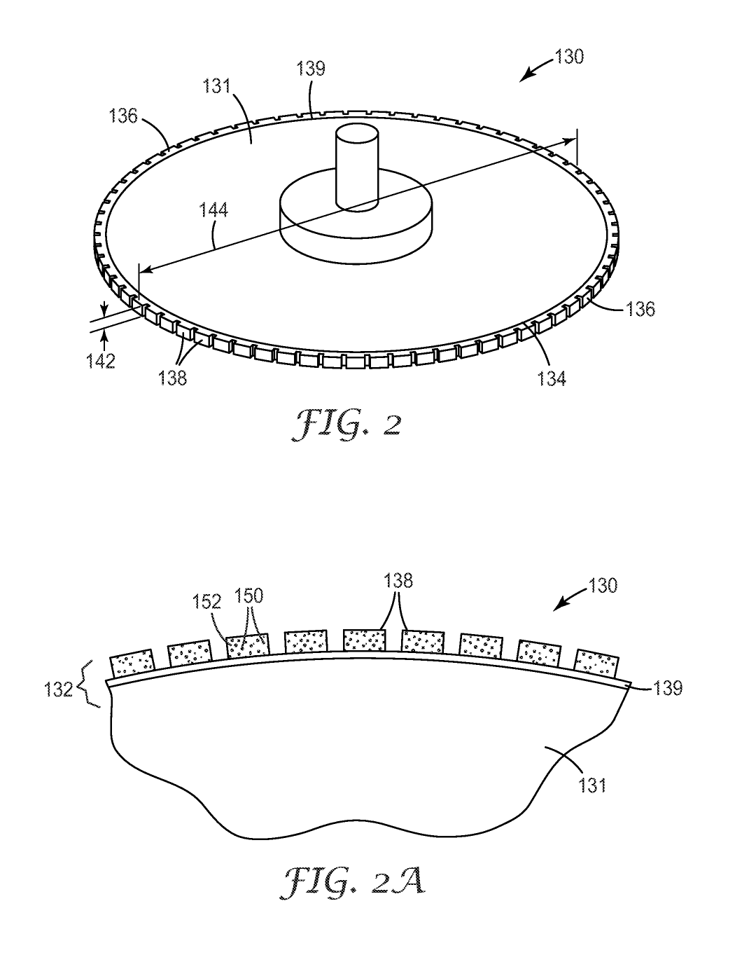

FIG. 1 illustrates one exemplary method 100 according to the present disclosure. Referring now to FIG. 1, dimple 110 (an exemplary recess) is formed in substrate 120 as abrasive wheel 130 (see also FIG. 2 and description below) driven by first motor 190 frictionally contacts surface 122 of substrate 120 mounted in holding assembly 127 and driven by second motor 192 is rotated. In the embodiment shown, abrasive wheel 130 rotates about first rotational axis 162. As it rotates, structured abrasive layer 136 of abrasive wheel 130 longitudinally advances along first direction 160 at surface 122 of substrate 120 (see FIG. 1A). Simultaneously, substrate 120 rotates about second rotational axis 164 which is substantially orthogonal to first rotational axis 162. As the process continues, dimple 110 gradually forms, with the size of the dimple being governed by the depth of penetration of the abrasive article into the substrate.

The rate at which abrasion occurs will depend on factors such as frictional contact pressure, abrasive grain size, rotational speed of the abrasive wheel (or abrasive belt), abrasive particle size and hardness, and shape and density of the shaped abrasive composites. Typically, larger and/or harder abrasive particles abrade substrate 120 the fastest, but leave a rougher finish than smaller and/or softer abrasive particles. Accordingly, it may be desirable to carry out the process using a relatively larger and/or harder abrasive particle (e.g., using 3M TRIZACT DIAMOND TILE 677XA 20-micron diamond nominal grade structured abrasive, available from 3M Company, St. Paul, Minn.) to rough in the recess, then repeating the process using a smaller and/or softer abrasive particle (e.g., using 3M TRIZACT LAPPING FILM CERIUM OXIDE M-568XA (0.5 micron) structured abrasive, available from 3M Company, St. Paul, Minn.) to provide an optically polished finish.

For larger recesses (e.g., a dimple 110 having a diameter greater than about 0.125 inch), a two-step procedure such as that described above is typically preferred. For a smaller recess, a single step may be sufficiently fast to achieve a fine surface finish in a single application of the method (e.g., using ceria abrasive).

Referring now to FIGS. 2 and 2A, exemplary abrasive wheel 130 comprises structured abrasive member 132 disposed along the peripheral surface 134 of support wheel 131. Structured abrasive member 132 comprises structured abrasive layer 136 secured to backing 139. Structured abrasive layer 136 comprises shaped abrasive composites 138 comprising abrasive particles 150 retained in organic binder material 152. Structured abrasive layer 136 has a substantially uniform width 142. To be useful for forming high quality dimples, support wheel 131 has diameter 144. The ratio of width 142 to diameter 144 is less than or equal to 0.125.

Advantageously, methods according to the present disclosure can be carried out in the absence of added loose abrasive particles and/or added abrasive slurry comprising the abrasive particles in a liquid vehicle, although this is not a requirement. This generally results in reduced mess and waste, and provides sharper edge definition where dimple 110 contacts the surrounding surface 122 of substrate 120.

The abrasive article may include, for example, an abrasive wheel 130 (e.g., as shown in FIGS. 1 and 2), an abrasive roller, an abrasive drum, or an abrasive belt. Preferably, the width (e.g., width 142) of the support member (e.g., support wheel 131) should be about the same as the width of the structured abrasive layer (e.g., structured abrasive layer 136) that is mounted to its outer peripheral surface (e.g., peripheral surface 134), although this is not a requirement. In some examples, the surface of the abrasive article could also have a convex shape, across the width of the wheel face (e.g., width 142), where the curvature of the convex shape is substantially equal to the radius of the abrasive article (e.g., abrasive wheel 130). This could be accomplished with a conformable-backed abrasive or by dressing the shape into the surface of the abrasive article prior to abrading the substrate. The abrasive article is generally driven by a motor (e.g., first motor 190), although manual power also may be used.

Preferably, structured abrasive layer 136 is longitudinally advanced around an axis of rotation where it is in frictional contact with the surface of the substrate (e.g., surface 122 of substrate 120 in FIG. 1). This is inherently achieved in the case that the abrasive article is an abrasive wheel 130, an abrasive roller, or an abrasive drum, and also corresponds to travel of an abrasive belt around a wheel (e.g., a drive wheel or a guide wheel). In such embodiments, the axes of rotation of the abrasive article (e.g., abrasive wheel 130) and the surface of the substrate (e.g., surface 122 of substrate 120 in FIG. 1) should not be parallel. In some embodiments, the axes of rotation are substantially orthogonal; however, this is not a requirement.

To form dimple 110 in substrate 120, the area of frictional contact between the abrasive article (abrasive wheel 130) and substrate 120 generally includes a point on the rotational axis of substrate 120, which corresponds to the deepest point of dimple 110.

In other embodiments, the place of frictional contact between the abrasive article (e.g., abrasive wheel 130) and substrate 120 can be moved and/or offset relative to the center of rotation of substrate 120. For example, if surface 122 of substrate 120 rotates about a first rotational axis, and abrasive wheel 130 rotates about a second rotational axis (e.g., that is not parallel to the first rotational axis), abrasive wheel 130 and/or substrate 120 may be translated along a third, different direction in a plane parallel to surface 122 of substrate 120. Such motion may result in a groove having a surface shaped as a portion of a cylinder with spherically rounded ends, e.g., a trench, an oval, or an ellipsoid.

In yet further embodiments, the area of frictional contact between the abrasive article (e.g., abrasive wheel 130) and substrate 120 may be offset from the rotational axis of substrate 120. For example, if surface 122 of substrate 120 rotates about a first rotational axis that is laterally offset from the area of frictional contact, and abrasive wheel 130 rotates about a second rotational axis (i.e., not parallel to the first rotational axis), the method will generally result in a ring-shaped recess having a surface corresponding to a portion of a torus.

In practice of methods according to the present disclosure, frictional contact is established between the abrasive article (e.g., abrasive wheel 130) and surface 122 of substrate 120, resulting over time in the abrasive article penetrating into substrate 120. Abrasion of substrate 120 and formation of dimple 110 (e.g., a recess) is thus achieved by applying a level of force to the abrasive article and/or substrate 120 that urges them toward each other in combination with other motion(s) of the abrasive article and substrate 120. Selection of an appropriate amount of applied force is within the capabilities of one of ordinary skill in the art. Preferably, the force is sufficient to achieve a good rate of abrasion, but not so high that stiction occurs.

In some embodiments, the abrasive article (e.g., abrasive wheel 130) is aligned substantially perpendicularly (e.g., perpendicularly or nearly perpendicularly) to surface 122 of substrate 120 while abrading substrate 120. In some embodiments, the abrasive article may be inclined at an angle of less than 90, 80, 70, 60, 50, 40, 30, or even less than 20 degrees relative to surface 122 of substrate 120.

During abrading of substrate 120, an abrading liquid may be used to reduce heat buildup and/or carry away debris. Abrading liquids include, for example, water, water containing one or more surfactants (e.g., as described in U.S. Pat. No. 7,278,904 to Woo et al.), oil, glycol, or other lubricant.

Substrate 120 may include any shape. In some embodiments, substrate 120 has a substantially planar surface, while in other embodiments the surface of substrate 120 may be convex, concave, planar, or a combination thereof. Examples of suitable substrate shapes include sheets, blocks, wafers, and slabs. Substrate 120 may include any material, but preferably substrate 120 (and especially substrate surface 122 to be abraded) comprises at least one of a glass, ceramic (such as sapphire), or glass-ceramic material. Examples of suitable glasses include soda-lime silica glasses, borosilicate glasses, fluoride glasses, aluminosilicate glasses (e.g., phosphate glasses, borate glasses, and chalcogenide glasses), aluminoborosilicate glasses, such as those described in U.S. Patent Application Publication No. 2012/0135852 to Ellison et al., and chemically-strengthened glasses (e.g., alkali-aluminosilicate sheet-toughened glass marketed under the trade designation GORILLA GLASS by Corning, Corning, N.Y.). Examples of suitable ceramics include alumina, sapphire, ruby, zirconia, yttria, and/or rare-earth oxide containing glass-ceramics, and combinations thereof. In preferred embodiments, substrate 120 is transparent, although this is not a requirement. In some of those embodiments, substrate 120 is substantially colorless. In some embodiments, substrate 120 comprises metal or a metal alloy.

Advantageously, methods according to the present disclosure can create a variety of recesses including, for example, dimples, ellipsoidal recesses (i.e., having surface shaped as a portion of an ellipsoid), oval recesses, trough recesses, and ring recesses (e.g., depressed rings or grooves having a surface shaped as a section of a torus). In typical embodiments, the recess has a smooth, continuously concave surface, although this is not a requirement. In some examples, the recess may include a substantially consistent (e.g., constant) radius of curvature for at least about 98% of the depth of the recess (e.g., where the depth is measured from a deepest point of the recess (e.g., dimple 110) to the plane of surface 122 in a direction substantially normal to surface 122). In some examples, the radius of curvature of the recess may be substantially consistent (e.g., constant) in all planes normal to the plane of surface 122 (e.g., when the recess includes a dimple 110). In other examples, the radius of curvature of the recess may be substantially consistent (e.g., constant) in at least one plane normal to the plane of surface 122 (e.g., when the recess includes an ellipsoidal recess, and oval recesses, trough recesses, and ring recesses).

Also, in typical embodiments, the recess terminates abruptly at a well-defined boundary where the recess abuts surface 122 of substrate 120, although this is not a requirement. In some examples, edge roll off is confined to less than about 2% of the total depth of the recess (e.g., where the depth is measured from a deepest point of the recess to the plane of surface 122 in a direction substantially normal to surface 122), such as between about 0.1% and about 2% of the total depth of the recess. Edge roll off refers to curvature between surface 122 of substrate 120 and the surface of the recess, e.g., instead of a sharply defined edge between surface 122 and the surface of the recess. These characteristics of the recess make the method well-suited for preparing electronic display covers (e.g., display covers adapted for tactile interaction using a finger or stylus).

Methods according to the present disclosure may be used to form recesses with complex shapes in substrates, including display covers, cover sheets, and/or housings, such as, for example, electronic display covers, medical device covers, sensor apparatus covers, and/or portable electronic device housings. Some example structures including recesses will now be described.

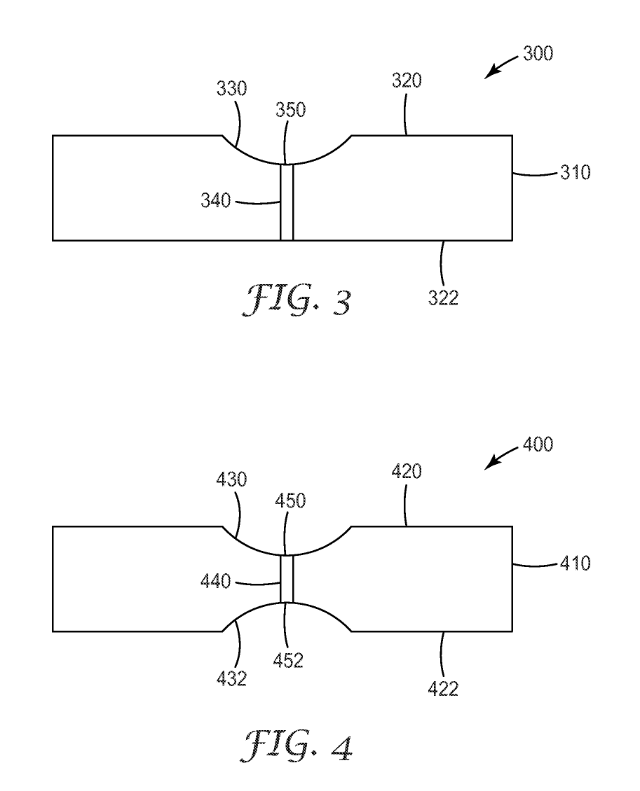

For example, a dimple may be formed that is centered over a cylindrical hole (i.e., a via) extending through the substrate. In such an instance, it is typically preferred to form the cylindrical hole (e.g., by boring) prior to practicing one or more methods according to the present disclosure. By so doing, any chips in the substrate that may have been formed by boring may be removed during the abrading process. One example structure is shown in FIG. 3. Cover 300 comprises chemically-strengthened glass sheet 310, which has first and second opposed parallel major surfaces 320, 322. Spherically concave recess 330 abuts and extends inwardly from first major surface 320. At its deepest point 350, spherically concave recess 330 abuts cylindrical passage 340, which extends between and abuts spherically concave recess 330 and second major surface 322. Cylindrical passage 340 is substantially perpendicular to first and second opposed parallel major surfaces 320, 322. In some examples, cylindrical passage 340 can be used to electrically connect components located adjacent to first parallel major surface 320 and second parallel major surface 322. For example, one or more electronic components, such as a pressure sensor, a capacitive sensor, a haptic device, or the like, can be disposed in spherically concave recess 330 and electrically connected to another electrical component located adjacent to second parallel major surface 322 using cylindrical passage 340, e.g., using an electrically conductive coating formed on a surface of cylindrical passage 340.

Referring now to FIG. 4, display cover 400 comprises transparent sheet 410 which has first and second opposed parallel major surfaces 420, 422. First spherically concave recess 430 abuts and extends inwardly from first major surface 420. Second spherically concave recess 432 abuts and extends inwardly from second major surface 422. Cylindrical passage 440, which extends between and abuts first and second spherically concave recesses 430, 432 at their deepest points 450, 452, is perpendicular to first and second opposed parallel major surfaces 420, 422. In some examples, cylindrical passage 440 can be used to electrically connect components located adjacent to first parallel major surface 420 and second parallel major surface 422, e.g., disposed in first spherically concave recess 430 and second spherically concave recess 432, e.g., using an electrically conductive coating formed on a surface of cylindrical passage 440. In other examples, one or more components may be located at least partially within cylindrical passage 340 of FIG. 3 or cylindrical passage 440 of FIG. 4. Recesses such as those shown in FIGS. 3 and 4 may be useful for fabrication as a component in the fabrication of interactive elements proximate to the display cover.

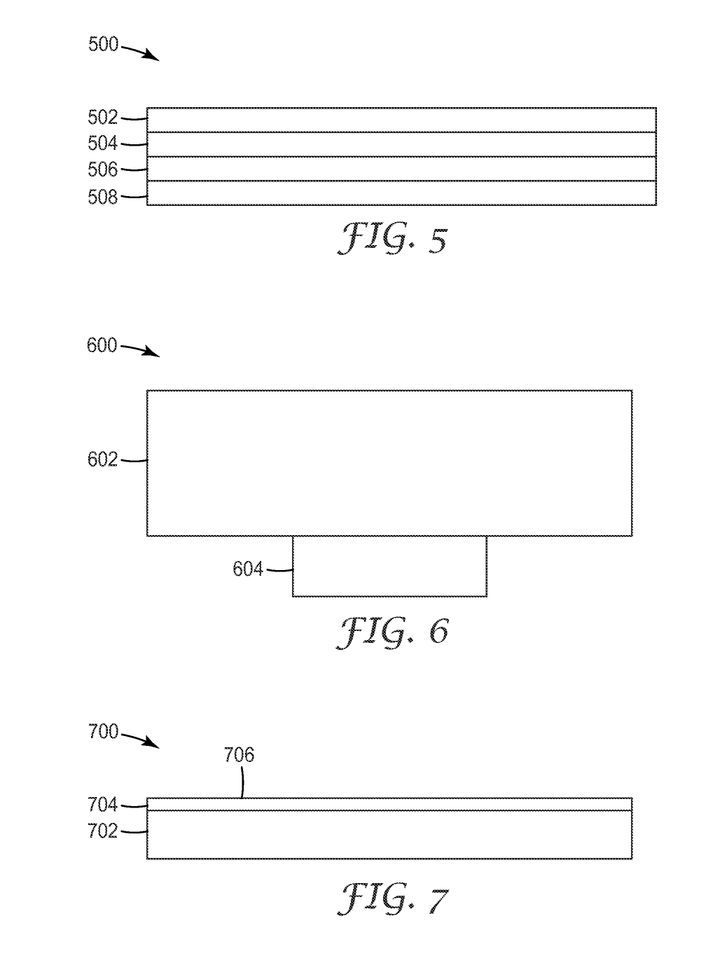

In some examples, the techniques described herein may be used to form recesses (e.g., dimple 110, an ellipsoidal recess, oval recess, trough recess, or a ring recess) in substrates that have at least one additional layer formed thereon or therein, e.g., by prior processing of the substrate. In some instances, the at least one layer may be mechanically attached to the substrate using a fastener, such as a clip, adhesive, or the like. For example, the techniques described herein may be used to form recesses in a glass substrate that is part of a display assembly. FIG. 5 is a conceptual and schematic diagram of an example display assembly 500. Display assembly 500 may include, for example, a cover glass 502, one or more optical films 504, a liquid crystal layer 506, and a backlight 508. In some examples, cover glass 502 may be attached to one or more of the optical films 504, the liquid crystal layer 506 can be attached to the opposite side of the one or more optical films 504, and backlight 508 can be disposed on the opposite side of the liquid crystal layer 506 from the cover glass 502. In other examples, display assembly can include additional layers, such as, for example, additional optical film layers disposed between backlight 508 and liquid crystal layer 506. Liquid crystal layer 506 and backlight 508 may be electrically connected to a control circuit (not shown in FIG. 5), which controls operation of liquid crystal layer 506 and backlight 508.

FIG. 6 is a conceptual and schematic diagram of another example assembly including a cover sheet and a component attached to the glass cover. In the example of FIG. 6, assembly 600 includes a cover sheet 602 and an electronic module 604. Electronic module 604 may include, for example, an optical sensor, an infrared sensor, a haptic device, a presence-sensitive sensor, a biometric sensor, or any other electronic device or module described herein. In some examples, electronic module 604 may include an optical and/or infrared sensor such as a charge-coupled device (CCD) sensor or a complementary metal-oxide semiconductor (CMOS) sensor, along with accompanying processing circuitry. In some examples, a recess formed in cover sheet 602 may function as a lens for the optical and/or infrared sensor.

FIG. 7 is a conceptual and schematic diagram of another example assembly including a glass cover. Assembly 700 shown in FIG. 7 may include a treated glass substrate 702, e.g., in which the at least one layer is formed by chemically treating a glass substrate 702 to form a chemically modified layer 704 proximate to surface 706 of glass substrate 702 or a chemical coating formed on a surface 706 of glass substrate 702. Although only a single chemically modified layer 704, in other examples, all surface of glass substrate 702 may include a chemically modified layer 704 proximate to the surface. In some examples, the treated glass substrate 702 may include a laminated glass, such as a glass substrate coated with an acrylic or methacrylic coating formed on a surface of glass substrate 702 using, e.g., dipping, roller coating, or spraying. In some examples, glass substrate 702 may be formed by a fusion draw process. The acrylic or methacrylic coating can include, for example, an acrylic or methacrylic acid copolymer. Once the coating has been deposited on the surface of the glass substrate, the coating can be dried, cured, or baked. Examples of laminated glasses that can be used in the techniques of this disclosure include those described in U.S. Patent Application Publication No. 2009/0258187 A1 (Brady et al.).

In other examples, treated glass substrate 702 may include a chemically-strengthened glass, such as an aluminosilicate glass material. In some examples, the aluminosilicate glass material can include an alkali aluminosilicate glass material. In other examples, the aluminosilicate glass material can be alkali-free.

In some examples, the aluminosilicate glass material may include at least one surface that has been exposed to an ion-exchange treatment. In the ion-exchange treatment, smaller metal ions present in the glass may be replaced with larger metal ions. In some instances, the smaller metal ions and larger metal ions are of the same valence. The ion-exchange treatment may treat a surface layer of the aluminosilicate glass. By replacing the smaller metal ions with the larger metal ions, a compressive stress is produced in surface layer 704, which strengthens surface layer 704 of the aluminosilicate glass.

In some examples, the ion-exchange process may be performed by immersing the aluminosilicate glass in a molten salt of the larger metal ion. Surface layer 704 may have a depth greater than or equal to 2% of the thickness of the aluminosilicate glass. Further details regarding a chemically-strengthened aluminosilicate glass may be found in U.S. Patent Application Publication No. 2011/0165380 A1 (Gahagan et al.).

Because the techniques described in this disclosure can be performed without added loose abrasive particles and/or added abrasive slurry, they may be performed on glass substrates with at least one additional layer formed therein or thereon. This may allow fabrication of devices with close registration between an electronic component and the recess. For example, a recess may be formed in a glass or sapphire cover layer above and in close registration with electronic module 604 (FIG. 6). In some examples, the recess may be configured as a lens for electronic module 604. As another example, a recess may be formed in a glass or sapphire cover layer above and in close registration with a sensor underlying the cover layer.

In contrast, using chemical etching or slurry-based abrasion to form a recess in a substrate after attaching an electronic component to the substrate may not be practical due to the sensitivity of the electronic component to liquids in the slurry and/or the harsh etching chemicals. Similarly, using molding to form a recess in a substrate after attaching an electronic component to the substrate or forming a laminated glass or chemically-treated glass may not be practical due to the sensitivity of the electronic component or the coating/treated surface to the temperatures used to mold the glass. Thus, the techniques described herein may provide added flexibility in manufacturing articles that include a substrate with a recess formed therein.

The techniques for forming recesses in a substrate may be used to facilitate construction and manufacturing of a variety of devices and assemblies. Example devices and assemblies that include recesses formed using techniques described herein will now be described.

In some examples, because dimple 110 may include a polished surface with relatively low surface roughness and controlled curvature, dimple 110 may be configured to be a lens. In some examples, the compressibility of structured abrasive layer 136, which includes shaped abrasive composites 138 comprising abrasive particles 150 retained in organic binder material 152, can be controlled to control the curvature of dimple 110. For example, when structured abrasive layer 136 is relatively less compressible, the shape of dimple 110 may more closely reproduce the shape of abrasive wheel 130. For example, the radius of curvature of the spherical dimple may be substantially equal to radius of the abrasive wheel 130. Hence, when abrasive wheel 130 is shaped as a circle and structured abrasive layer 136 is relatively less compressible, the shape of dimple 110 may be described as a function of a surface of a sphere. In some examples, dimple 110 may include a substantially consistent (e.g., constant) radius of curvature for at least about 98% of the depth of the recess (e.g., where the depth is measured from a deepest point of the recess (e.g., dimple 110) to the plane of surface 122 in a direction substantially normal to surface 122). In contrast, when structured abrasive layer 136 is relatively more compressible, the shape of dimple 110 may deviate more from the shape of abrasive wheel 130, and, thus, may deviate from a spherical shape.

In some examples, the surface roughness of the surface of dimple 110 can be relatively low, resulting in an optically smooth surface. For example, by using appropriate abrasive particles 150, the average surface roughness of the surface of dimple 110 may be less than about 30 Angstoms (Å). In some examples, the average surface roughness of the surface of dimple 110 may be substantially consistent throughout the surface of dimple 110, and may be controlled by selecting the grade and mineral type of abrasive used in structured abrasive layer 136.

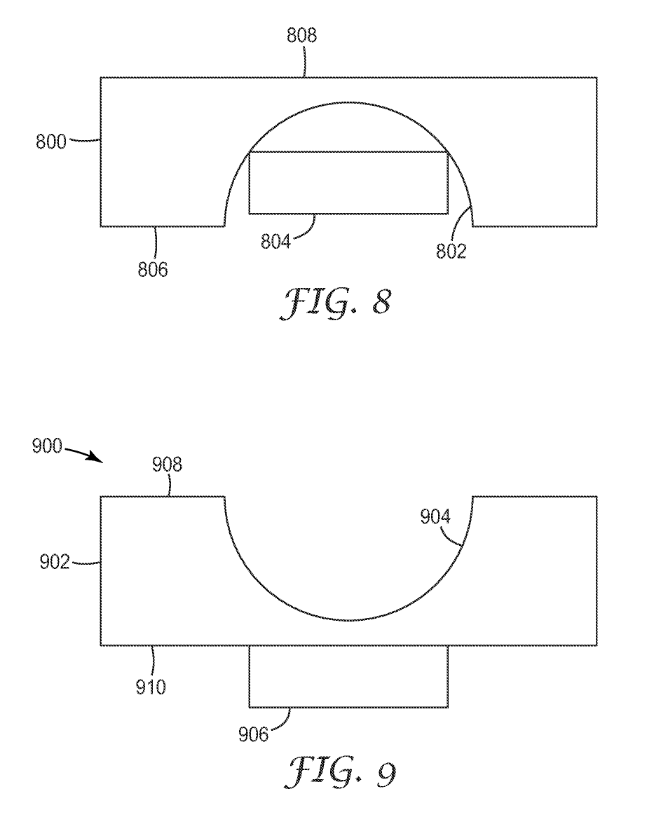

In some examples, dimple 110 may be used to allow a component to be placed at least partially within the volume defined by dimple 110. FIG. 8 is a conceptual and schematic diagram illustrating an example substrate 800 including a dimple 802 formed in a first surface 806 of substrate 800, and a component 804 disposed at least partially within the volume defined by dimple 802. As shown in FIG. 8, dimple 802 allows component 804 to be located closer to second surface 808 of substrate 800. This may provide one or more advantages, including for example, a thinner device compared to examples in which the component 804 is not disposed at least partially within the volume defined by dimple 802 and reduced material between the component 804 and second surface 808 of substrate 800.

Component 804 may include, for example, an electronic module, such as electronic module 604 (FIG. 6). The electronic module may include, for example, an optical sensor or an IR sensor, along with accompanying processing circuitry. Because there is less material between second surface 808 of substrate 800 and component 804, the path length to an optical or IR sensor may be reduced compared to a substrate that does not include a recess. In some examples, this may reduce distortion caused by substrate 800.

In some examples, dimple 802 may be a focusing lens for the electronic module (e.g., an optical sensor or IR sensor) located adjacent to dimple 802. As other examples, dimple 802 may be a lens for display for an electronic device, e.g., a magnifying lens for a portion of the display, e.g., of a television remote control, mobile computing device, or the like; a collector (focusing) lens for a solar panel, a lens for a three-dimensional (3D) optical effect formed by the combination of dimple 802 and an image underlying dimple 802; or the like.

In some examples, dimple 802 may be coated, laminated, or vapor deposited with one or more coatings. In some instances, the coating may include an optical coating, such as an antireflection coating, a high-reflector coating, a dielectric coating (e.g., using one or more materials with a different refractive index than substrate 800), or the like. In other examples, the coating may include a scratch-resistant coating. In other examples, the coating may include a luminescent coating. For example, when used dimple 802 is used as a button in a touch- or presence-sensitive input device, a luminescent coating may allow a user to more easily locate the button in low-light situations.

In other examples, component 804 may include a haptic device. By locating the haptic device at least partially within the volume defined by dimple 802, the haptic device may be located closer to second surface 808 of substrate 800. In some examples, locating the haptic device closer to second surface 808 may reduce the electrical power required to produce a similar haptic effect at second surface 808. Moreover, in some examples, locating the haptic device closer to second surface 808 may facilitate higher definition haptic signals. Higher definition haptic signals may include haptic signals that are more localized, e.g., to a location proximate to the haptic device rather than to a larger area or volume of the device in which the haptic device is integrated.

In some examples, dimple 802 may be sized such that the haptic device is disposed substantially fully within the volume defined by dimple 802. This may provide protection to the haptic device, and may also enhance efficiency of vibration transmission from the haptic device to substrate 800. In some examples, the haptic device and dimple 802 may be sized such that the haptic device does not contact the side walls of dimple 802 (e.g., the haptic device contacts substrate 800 only at locations of dimple 802 close to second surface 808). This also may enhance efficiency of vibration transmission from the haptic device to substrate 800.

In some examples, the haptic device may produce a tactile sensation or a kinesthetic sensation. As used herein, a tactile haptic device generates vibration, texture, or heat, while a kinesthetic haptic device is an active device (such as a piezoelectric actuator) or provides resistive force feedback.

In some examples, component 804 may include a component of a presence-sensitive device, such as a capacitive sensor. Similar to a haptic device, in some examples, locating the presence-sensitive sensor closer to second surface 808 may reduce the electrical power required to produce a sensing sensitivity at second surface 808, and, moreover, may allow the device in which substrate 800 is incorporated to be thinner.

In other examples, instead of component 804 being located at least partially within the volume defined by dimple 802 and second surface 808 being the user-facing surface, dimple 802 may be oriented to be on the user-facing surface of a substrate. FIG. 9 is a conceptual and schematic diagram illustrating an example assembly 900 including a substrate 902, a dimple 904, and a component 906 located adjacent to an opposite surface 910 from dimple 904. Dimple 904 is defined in first surface 908 of substrate 900, and component 906 is located adjacent to second surface 910.

In some examples, component 906 may be an electronic module (e.g., electronic module 604 of FIG. 6), and dimple 904 may allow the electronic module to have less material between the module and the environment on the opposite side of surface 908. Additionally or alternatively, dimple 904 may be configured to be a lens for focusing light on a sensor of the electronic module.

In other examples, component 906 may be a presence-sensitive sensor. Dimple 904 may be configured as a tactile button, e.g., as part of a touch- or presence-sensitive input device. For example, substrate 902 may form a cover glass for a presence-sensitive input device. The presence-sensitive input device may operate based on, for example, resistive, surface acoustic wave, capacitive, infrared, optical, dispersive signal, acoustic pulse sensing, or any other appropriate presence-sensitive technology. In various examples, the presence-sensitive input device may include or be associated with a computing device, such as smartphone or tablet computer, an automobile user interface, or the like. Because dimple 904 defines a relatively sharp edge when meeting surface 908 and a smooth curvature, dimple 904 may be easily locatable by a user using only touch. This may make dimple 904 useful as a tactile button for receiving user input. This may be useful when dimple 904 is located on the back of an electronics device including a display on the front surface or on an automotive display, where the button can be usefully operated vision free. In some examples, the tactile button may be associated with a dedicated function, such as a home function, a back function, or be configurable or configured to execute a single associated application, e.g., be a dedicated launcher button for the associated application. In other examples, the tactile button may be associated with a function that is dependent upon content displayed at a display device located below the tactile button.

In other examples, component 906 may be a biometric sensor. Dimple 904 may present a reproducible surface at which a user can present his or her fingertip to the biometric sensor. An example biometric sensor includes a fingerprint sensor, biomedical sensor or other diagnostic device.

In some examples, the examples illustrated in FIGS. 8 and 9 may be combined with a cylindrical passage (e.g., cylindrical passage 340 of FIG. 3 or cylindrical passage 440 of FIG. 4) between the dimple and the opposite surface of the substrate. The cylindrical passage 440 may provide a pathway for electrical connections to travel from one side of substrate 800 or 900 to the opposite side of the substrate 800 or 900.

For example, FIG. 10 is a conceptual and schematic diagram illustrating example assembly 1000 that includes a dimple 1004 formed in a first surface 1008 of substrate 1002, and a component 1006 located adjacent to second surface 1010 of substrate 1002. Additionally, assembly 1000 includes a cylindrical passage 1012 that extends between dimple 1004 and second surface 1010. Cylindrical passage 1012 may provide a passageway for an electrical connection between a component disposed within dimple 1004 and component 1006.

In other examples, a component may be disposed within cylindrical passage 1012. For example, a pressure sensor may be disposed within cylindrical passage 1012, with a surface of the pressure sensor near the surface of dimple 1004, such that the pressure sensor can sense pressure applied to the surface of dimple 1004. In this way, dimple 1004 may be a button actuated when pressure is applied to the surface of dimple 1004. In some examples, dimple 1004 may be located at a position of a device that is difficult for a user to see or visually focus on. For example, dimple 1004 may be located on a back (the side opposite to the screen) of a mobile computing device (e.g., a smartphone or tablet) or may be part of an automobile user interface. Dimple 1004 may allow the user to locate the button using primarily or only touch, rather than relying on sight.

As another example, a speaker or microphone may be positioned within cylindrical passage 1012, and dimple 1004 may function as a waveguide for the speaker or microphone. This may enhance the efficiency of the speaker or microphone.

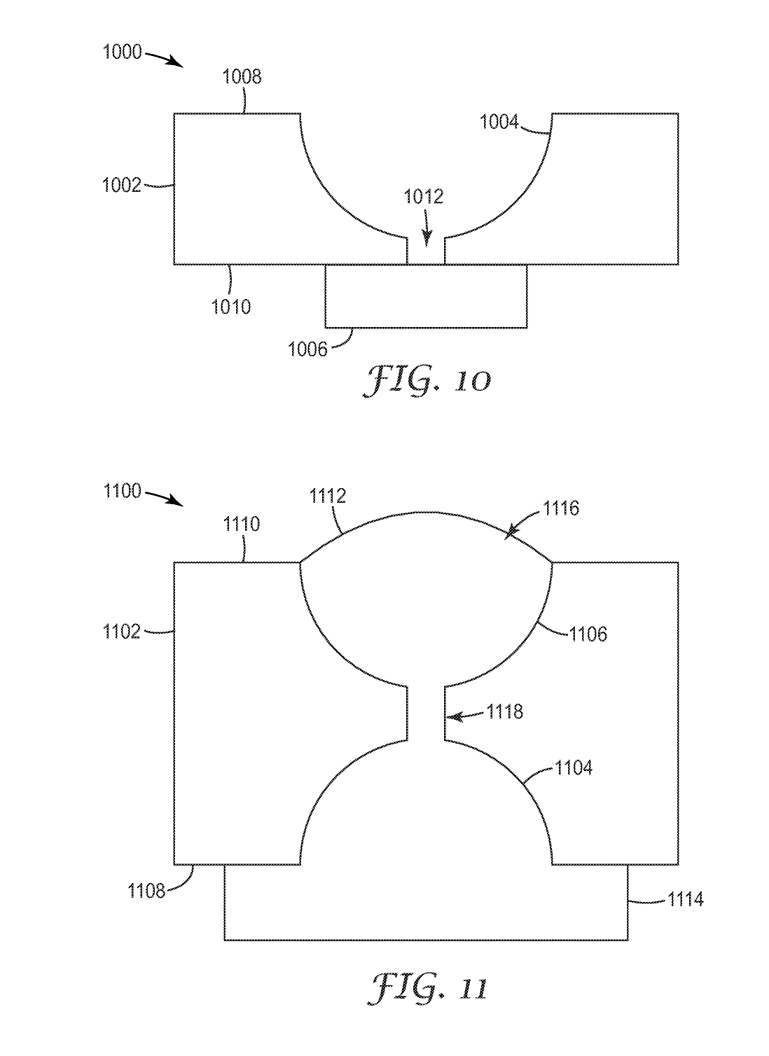

FIG. 11 is a conceptual and schematic diagram illustrating an example assembly 1100 that includes a first dimple 1104 formed in a first surface 1108 of substrate 1102, and a second dimple 1106 formed in second surface 1110 of substrate 1102. Additionally, assembly 1100 includes a cylindrical passage 1118 that extends between first dimple 1104 and second dimple 1106. Assembly 1100 further includes a reservoir 1114 adjacent to first surface 1108 and a flexible membrane 1112 attached to first surface 1110 and covering second dimple 1106.

Assembly 1100 may be a physical, raised button available responsive to predetermined events. For example, assembly 1100 may be a portion of a cover glass for a display. In response to a user interface element being displayed at the display at a location in registration with assembly 1100 (e.g., with second dimple 1106), a control module may cause the button to be raised, presenting a physical button with which a user can interact to select the user interface element.

FIG. 11 illustrates flexible membrane 1112 in a deflected position, which corresponds to the button being raised. To deflect flexible membrane 1112, a fluid 1116 (e.g., liquid, gas, or polymer) within reservoir 1114 is forced through cylindrical passage 1118 to second dimple 1106. The pressure of fluid 1116 deflect flexible membrane 1112, causing membrane 1112 to protrude from first surface 1110. When the button is no longer called for (e.g., when the user interface element is no longer displayed at the display), the pressure exerted on fluid 1116 within reservoir 1114 may be reduced, which allows fluid to flow back into reservoir 1114 from second dimple 1106. As the pressure of the fluid decreases, membrane 1112 may no longer be deflected. At an appropriate fluid pressure, membrane 1112 may form a surface substantially parallel to and co-planar with surface 1110.

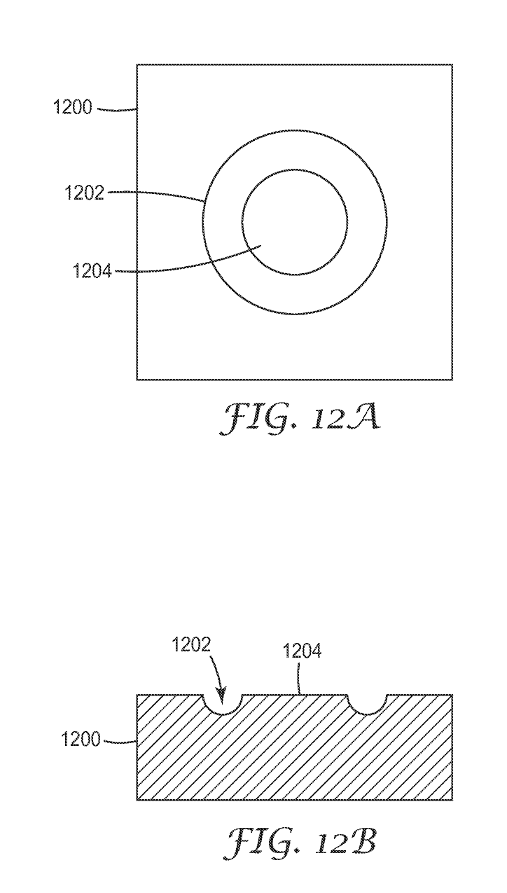

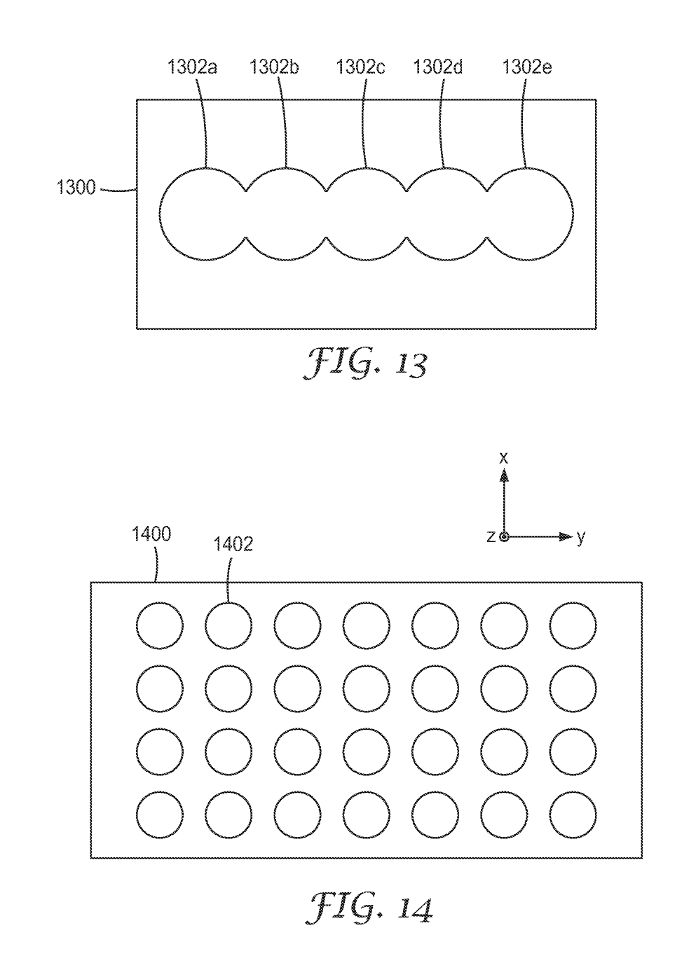

In some examples, the recess may not be formed as a dimple. Instead, the recess may be formed as a depressed ring or groove having a surface shaped as a section of a torus. FIGS. 12A and 12B are conceptual and schematic diagrams illustrating an example substrate 1200 including a depressed ring 1202 having a surface shaped as a section of a torus. The depressed ring 1202 defines a plateau 1204 within the depressed ring 1202. In some examples, the depressed ring 1202 can be a first user interface element (e.g., a first presence-sensitive portion of substrate 1200) and plateau 1204 can be a second user interface element (e.g., a second presence-sensitive portion of substrate 1200). For example, depressed ring 1202 may function as a knob or rotatable control, while plateau 1204 may function as a button. In some examples, instead of the portion within depressed ring 1202 including plateau 1204, the portion may include a dimple or other recess.

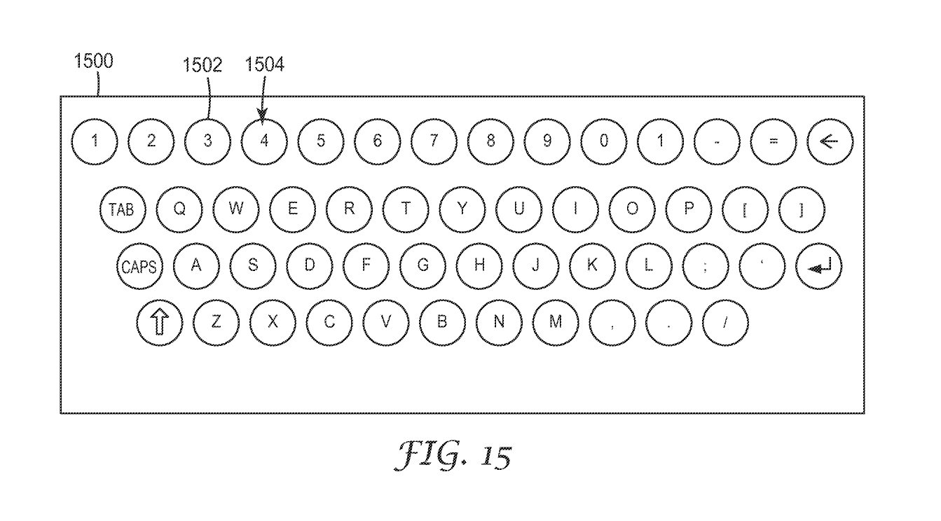

Although the foregoing examples have depicted assemblies including single recesses (e.g., dimples), in other implementations, assemblies may include a plurality of recesses formed in an array. FIGS. 13-15 are conceptual and schematic diagrams that illustrate example arrays of dimples. As shown in FIG. 13, substrate 1300 may include a linear array of dimples 1302a-1302e. In some examples, dimples 1302a-1302e may be formed such that they at least partially overlap, as shown in FIG. 13. In other examples, dimples 1302a-1302e may be formed such that they do not overlap.

FIG. 14 is a conceptual and schematic diagram illustrating a substrate 1400 that includes an array of dimples 1402. The array in the example of FIG. 14 includes a regular grid in which dimples 1402 are substantially aligned in rows (e.g., in the y-axis direction of FIG. 14, where orthogonal x-y-z axes are shown for purposes of illustration only) and columns (e.g., in the x-axis direction). In other examples, dimples 1402 may be offset from each other in the x-axis, the y-axis, or both. As dimples 1402 are spaced throughout an area of substrate 1400, haptic devices (or other components) may be spaced throughout the area of substrate 1400. By spacing haptic devices throughout the area of substrate 1400, the array of haptic devices may be used to provide localized haptic feedback at a plurality of locations of substrate 1400. This may allow the haptic feedback to be substantially localized to a location proximate to the location of substrate 1400 at which a touch event occurred.

FIG. 15 is a conceptual and schematic diagram illustrating another example substrate 1500 that includes an array of dimples 1502. As shown in the example of FIG. 15, the array of dimples 1502 is formed in a configuration similar to a QWERTY keyboard layout. FIG. 15 also illustrates a plurality of characters 1504. Respective ones of plurality of characters 1504 are substantially aligned with respective ones of dimples 1502. In this way, each of dimples 1502 may act as a button for a corresponding one of plurality of characters. For example, a presence-sensitive sensor (e.g., a capacitive sensor or a pressure sensor) may be located at each of dimples 1502, allowing a user to select the character by contacting the respective one of dimples 1502. In some examples, the plurality of characters 1504 may be displayed at a display device adjacent to substrate 1500, and substrate 1500 may include a cover glass. In this way, the plurality of characters 1504 may be able to change, e.g., to other characters or to reflect selected formatting options (e.g., rich text formatting). In other examples, the plurality of characters 1504 may be printed or otherwise permanently formed in a layer below substrate 1500.

In other examples, instead of an array of dimples 1502 in a configuration similar to a QWERTY keyboard layout, the array of dimples 1502 may be formed in any selecting layout. The layout may be selected based on the use to which substrate 1500 will be put. For example, an array of dimples 1502 may have a different layout when used as an automotive user interface (e.g., for climate controls, audio controls, or the like) than when used as a remote control (e.g., for a television or stereo).

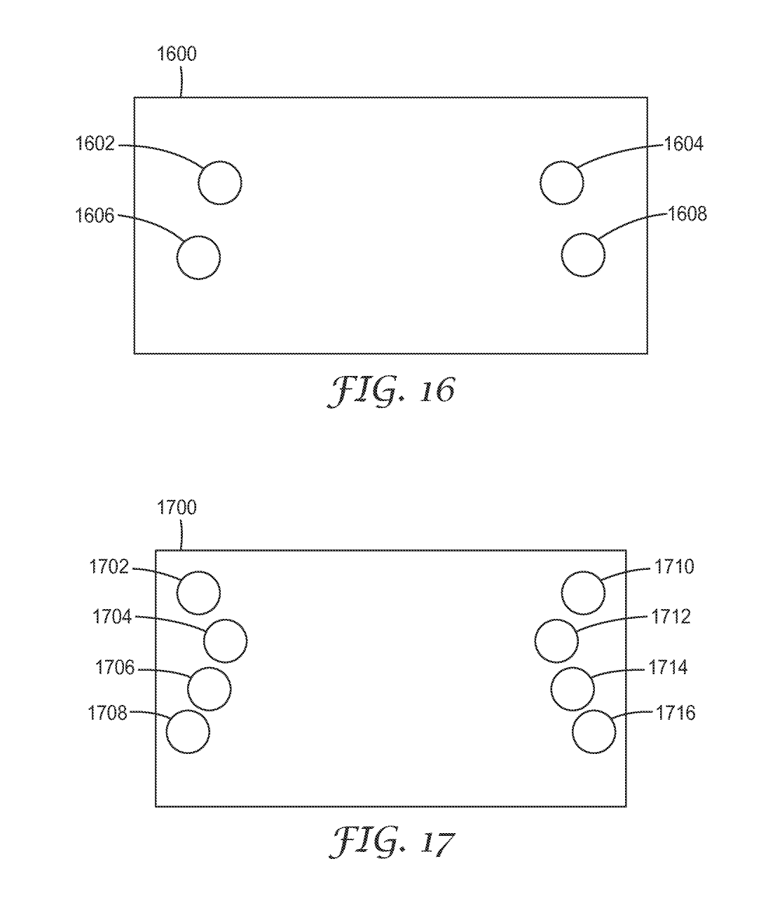

In other examples, a device or assembly may include an array of recesses formed in a housing or cover sheet (e.g., cover glass) of an electronic device, e.g., at locations of the housing or cover sheet where a user's fingers may rest while holding the electronic device. Such arrays of recesses may function as features that assist the user in gripping the electronic device or holding the electronic device with his or her hands in a particular position. FIG. 16 is a conceptual and schematic diagram that illustrates an example cover sheet 1600 with a four recesses 1602, 1604, 1606, and 1608 formed therein. In the example depicted in FIG. 16, recesses 1602-1608 are dimples. In other examples, at least one of recesses 1602-1608 may include a different shape, such as an ellipsoidal recess, a trough, an oval recess, or a ring recess. Additionally, in some examples, cover sheet 1600 may include fewer or more than four recesses 1602-1608.

Each of recesses 1602-1608 may be formed in cover sheet 1600 at a location determined to be approximately where a user will rest his or her fingers (e.g., thumbs) when holding the electronic device in a particular position or orientation. For example, first recess 1602 and second recess 1604 may be positioned such that when the user holds the electronic device in a first position or orientation, the user's thumbs rest on or near to first recess 1602 and second recess 1604, respectively. As another example, third recess 1606 and fourth recess 1608 may be positioned such that when the user holds the electronic device in a second position or orientation, the user's thumbs rest on or near to third recess 1606 and fourth recess 1608, respectively. In this way, recesses 1602-1608 may function as positioning aids for the user when interacting with the electronic device.

FIG. 17 is a conceptual and schematic diagram that illustrates an example portion of a housing 1700 that includes a plurality of recesses 1702-1716 that may function as grip aids or positioning aids for a user when interacting with an electronic device. In contrast to the example depicted in FIG. 16, plurality of recesses 1702-1716 are formed in the portion of the housing 1700 of the electronic device. For example, the portion of the housing 1700 may define a surface substantially opposite to a surface defined by a display of the electronic device, i.e., the portion of the housing 1700 may be a back of the electronic device. In some examples, the electronic device may be a portable computing device, such as a laptop computer, tablet computer or smartphone. In the example depicted in FIG. 17, recesses 1702-1716 are dimples. In other examples, at least one of recesses 1702-1716 may include a different shape, such as an ellipsoidal recess, a trough, an oval recess, or a ring recess.

In some examples, as shown in FIG. 17, first recess 1702, second recess 1704, third recess 1706, and fourth recess 1708 may be positioned in a physical configuration such that a user's forefinger, middle finger, ring finger, and little finger of one hand rest on or near first recess 1702, second recess 1704, third recess 1706, and fourth recess 1708, respectively, when the user is holding the electronic device. Similarly, fifth recess 1710, sixth recess 1712, seventh recess 1714, and eighth recess 1716 may be positioned in a physical configuration such that a user's forefinger, middle finger, ring finger, and little finger of the other hand rest on or near fifth recess 1710, sixth recess 1712, seventh recess 1714, and eighth recess 1716, respectively, when the user is holding the electronic device. In this way, recesses 1702-1716 may function as positioning aids for the user when interacting with the electronic device. In some examples, instead of including a single set of recesses 1702-1716, the portion of the housing 1700 may include a plurality of sets of recesses, e.g., to accommodate user's having different sized hands.

In the course of development of the methods of the present disclosure, the present inventors developed abrasive articles and methods for making them that were adapted to use with methods of the present disclosure. These will now be discussed in detail.

Abrasive wheels, abrasive drums, abrasive rollers, and abrasive belts useful for practicing the present disclosure may be formed using structured abrasives such as, for example, structured abrasive member 132 in FIG. 2A. In one method, strips of structured abrasive are adhered to the peripheral surface (i.e., edge) of support wheel (typically fitted with a suitable mechanical fastening system to connect to a drive source). Examples of suitable adhesives include glues and epoxy resins, although any material capable of making a secure bond may be used.

While in FIG. 2A, structured abrasive member 132 is secured to a support wheel, by omitting the support wheel, a structured abrasive belt can be made, for example, according to well-known techniques.

Suitable structured abrasives have a structured abrasive layer secured to a major surface of a backing. Suitable backings typically have a front surface and a back surface. Representative examples of materials useful for preparing backings include polymeric films (including primed polymeric films), compressible resilient foams (e.g., elastomeric foams), woven fabrics, knit fabrics, nonwoven fabrics, and combinations thereof. For use in abrasive wheels the backing preferably comprises a polymeric film. For use in abrasive belt the backing should have sufficient dimensional stability and durability, and preferably comprises a woven or knit material. Film backings can be used and may include adhesion promoters or anti slip coatings. In some preferred embodiments, the backing can be a polyethylene terephthalate film having a thickness of from about 2 to 8 mils (50 to 200 microns).

The backing can be transmissive or opaque to ultraviolet or visible radiation, or transmissive or opaque to both ultraviolet and visible radiation, although this is not a requirement. The backing may also be subjected to a treatment or treatments to seal the backing or modify some physical properties of the backing, or both. These treatments are well-known in the art. For example, cloth backings may contain a saturant coat, a backsize coat, a presize coat, or any combination thereof. The saturant coat saturates the backing and fills in the small openings in the backing. The backsize coat, which is applied to the backside of the backing, can protect the fibers or yarns during use. The presize coat is applied to the front side of the backing. The presize coat on the front side of the cloth functions to seal the cloth. Examples of resins useful for treating cloth include phenolics, latexes, epoxies, acrylates, acrylated epoxies, acrylated urethanes, polyesters, starches, and combinations thereof. The resins for treating cloth may further comprise additives, such as, for example, fillers, fibers, coupling agents, wetting agents, dyes, and pigments.

The structured abrasive layer may be formed on the backing by filling cavities in a production tool with a mixture of abrasive particles and a curable binder precursor, contacting the backing with the production tool and binder precursor and then sufficiently curing the binder precursor, such that separation of the backing from the production tool causes the shaped abrasive composites formed in the production tool to remain secured to the backing, thereby forming a structured abrasive layer.

The structured abrasive layer is secured to the backing such that it does not separate from the backing during intended use. The shaped abrasive composites may have any shape, but typically comprise pyramids (e.g., 3- or 4-sided pyramids), truncated pyramids (e.g., 3- or 4-sided truncated pyramids), prisms (e.g., 3-, 4-, or 6-sided prisms), rods, cones, truncated cones, and combinations thereof. Combinations of differently shaped abrasive composites and/or different heights of shaped abrasive composites may be used. For example, pyramidal shaped abrasive composites may be interspersed with truncated pyramidal shaped abrasive composites of lesser height. The shaped abrasive composites may be regular (having all sides identical) or irregular.

The shaped abrasive composites define the structured abrasive layer and are typically arranged in close-packed arrangements (e.g., arrays) wherein adjacent shaped abrasive composites contact one another at their respective bases, although separation between at least some adjacent abrasive composites is permissible. Gaps (e.g., stripes) in the topographically structured abrasive layer may be present.

The height of the shaped abrasive composites relative to the backing is typically in a range of from 10 to 900 microns, although greater or lesser heights may also be used. More typically, the height of the abrasive composites relative to the backing is in a range of from 50 to 850 microns, or even in a range of from 75 microns to 800 microns.

In some embodiments, the areal density of the abrasive composites in the topographically structured abrasive layer is typically in a range of from at least 1,000, 10,000, or even at least 20,000 abrasive composites per square inch (e.g., at least 150, 1,500, or even 7,800 abrasive composites per square centimeter) up to and including 50,000, 70,000, or even as many as 100,000 abrasive composites per square inch (up to and including 7,800, 11,000, or even as many as 15,000 abrasive composites per square centimeter), although greater or lesser densities of abrasive composites may also be used.

The shaped abrasive composites may also comprise diluent particles, typically with sizes on the same order of magnitude as the abrasive particles. Examples of such diluent particles include gypsum, marble, limestone, flint, silica, glass bubbles, glass beads, and aluminum silicate.

The mixture to be used to form abrasive composites comprises a plurality of abrasive particles dispersed in a binder precursor. As used herein, the term “mixture” means any composition comprising a plurality of abrasive particles dispersed in a binder precursor. It is preferred that the mixture be flowable. However, if the mixture is not flowable, it can be extruded or forced by other means (e.g., heat, pressure, or both) onto the contacting surface of the production tool or onto the front surface of the backing. The mixture can be characterized as being conformable, that is, it can be forced to take on the same shape, outline, or contour as the contacting surface of the production tool and the front surface of the backing.

The abrasive particles typically have a size ranging from about 0.1 to 100 microns, preferably from about 0.2 to 50 microns, and more preferably from 0.5 to 45 microns, although other sizes may also be used. Examples of abrasive particles suitable for use in structured abrasives according to the present disclosure include fused aluminum oxide, ceramic aluminum oxide, heat treated aluminum oxide, white aluminum oxide, green silicon carbide, silicon carbide, alumina, zirconia, diamond, ceria, cubic boron nitride, garnet, silica, and combinations thereof. The phrase “abrasive particles” includes both individual abrasive grits and a plurality of individual abrasive grits bonded together to form an agglomerate. The abrasive particles may have a surface treatment thereon. In some instances, the surface treatment may increase adhesion to the binder, alter the abrading characteristics of the abrasive particle, or the like. Examples of surface treatments include coupling agents (e.g., silane coupling agents), halide salts, metal oxides including silica, refractory metal nitrides, and refractory metal carbides.

The binder precursor is capable of being cured by energy, preferably radiation energy, more preferably, radiation energy from ultraviolet light, visible light, or electron beam sources. Other sources of energy include infrared, thermal, and microwave. It is preferred that the energy not adversely affect the production tool used in the method of the invention, so that the tool can be reused. The binder precursor can polymerize via a free radical mechanism or a cationic mechanism. Examples of binder precursors that are capable of being polymerized by exposure to radiation energy include (meth)acrylates, acrylated urethanes, acrylated epoxies, ethylenically unsaturated compounds, aminoplast derivatives having pendant unsaturated carbonyl groups, isocyanurate derivatives having at least one pendant acrylate group, isocyanate derivatives having at least one pendant (meth)acrylate group, vinyl ethers, epoxy resins, and combinations thereof. As used herein, the term “(meth)acrylate” refers to acrylates and/or methacrylates.

If either ultraviolet radiation or visible radiation is to be used, it is preferred that the binder precursor further comprise free-radical photoinitiator and/or cationic photocatalyst to facilitate curing of the binder precursor. Examples of free-radical photoinitiators include organic peroxides, azo compounds, quinones, benzophenones, nitroso compounds, acyl halides, hydrazones, mercapto compounds, pyrylium compounds, bisimidazoles, phosphine oxides, chloroalkyltriazines, benzoin ethers, benzil ketals, thioxanthones, acetophenone derivatives, sensitized iodonium salts, and combinations thereof.

Cationic photocatalysts generate an acid source, e.g., to initiate the polymerization of an epoxy resin. Cationic photocatalysts can include a salt having an onium cation and a halogen containing a complex anion of a metal or metalloid. Other cationic photocatalysts include a salt having an organometallic complex cation and a halogen containing complex anion of a metal or metalloid. Cationic photocatalysts are further described in U.S. Pat. No. 4,751,138 (Tumey et al.) and U.S. Pat. No. 4,985,340 (Palazzotto et al.).

In addition to the radiation curable resins, the binder precursor may further comprise resins that are curable by sources of energy other than radiation energy, such as condensation curable resins. Examples of such condensation curable resins include phenolic resins, melamine-formaldehyde resins, and urea-formaldehyde resins.

The binder precursor can further comprise optional additives, such as, for example, fillers (including grinding aids), fibers, lubricants, wetting agents, surfactants, pigments, dyes, coupling agents, plasticizers, and suspending agents. The amounts of these materials can be adjusted to provide the properties desired. Examples of fillers include calcium carbonate, silica, quartz, aluminum sulfate, clay, dolomite, calcium metasilicate, and combinations thereof. Examples of grinding aids include potassium tetrafluoroborate, cryolite, sulfur, iron pyrites, graphite, sodium chloride, and combinations thereof. The mixture can contain up to 70 weight percent (wt. %) filler or grinding aid, typically up to 40 wt. %, preferably from 1 to 10 wt. %, and more preferably from 1 to 5 wt. %.

The mixture can be prepared by mixing the ingredients, preferably by a low shear mixer. A high shear mixer can also be used. Typically, the abrasive particles are gradually added into the binder precursor. Additionally, it is possible to minimize the amount of air bubbles in the mixture. This can be accomplished by applying a vacuum during the mixing step.

During manufacture, radiation energy is typically transmitted through the production tool and/or backing and into the mixture to at least partially cure the binder precursor. The phrase “partial cure” means that the binder precursor is polymerized to such a state that the resulting mixture releases from the production tool. The binder precursor can be fully cured once it is removed from the production tool by any energy source, such as, for example, thermal energy or radiation energy. The binder precursor can also be fully cured before the shaped abrasive composites are removed from the production tool.

Sources of radiation energy preferred for structured abrasives according to the present disclosure include electron beam, ultraviolet light, and visible light. Other sources of radiation energy include infrared and microwave. Thermal energy can also be used. Electron beam radiation, which is also known as ionizing radiation, can be used at a dosage of about 2 to 25 megarads (Mrad), preferably at a dosage of about 10 to 20 Mrad. Ultraviolet radiation refers to non-particulate radiation having a wavelength within the range of about 200 to about 400 nanometers, preferably within the range of about 250 to 400 nanometers. It is preferred that ultraviolet radiation be provided by ultraviolet lights. Visible radiation refers to non-particulate radiation having a wavelength within the range of about 400 to about 800 nanometers, preferably within the range of about 400 to about 550 nanometers.

If the radiation energy is transmitted through the production tool and/or the backing and directly into the mixture, it is preferred that the material from which the production tool and/or the backing is made not absorb an appreciable amount of the radiation energy or be degraded by it. For example, if electron beam energy is used, it is preferred that the production tool and/or the backing not be made from a cellulosic material, because the electrons will degrade the cellulose. If ultraviolet radiation or visible radiation is used, the production tool and/or the backing material should transmit sufficient ultraviolet or visible radiation, respectively, to bring about the desired level of cure.

The production tool should be operated at a velocity that is sufficient to avoid degradation of the tool and/or the backing by the source of radiation. In examples in which the production tool and/or the backing have relatively high resistance to degradation by the source of radiation, the production tool can be operated at relatively lower velocities. In examples in which the production tool and/or the backing have relatively low resistance to degradation by the source of radiation, the production tool can be operated at relatively higher velocities. In short, the appropriate velocity for the production tool depends on the materials from which the production tool and/or the backing are made.

The production tool can be in the form of a belt, e.g., an endless belt, a sheet, a continuous sheet or web, a coating roll, a sleeve mounted on a coating roll, or die. The surface of the production tool that will come into contact with the mixture can be smooth or can have a topography or pattern. This surface is referred to herein as the “contacting surface”. If the production tool is in the form of a belt, sheet, web, or sleeve, it will have a contacting surface and a non-contacting surface. If the production tool is in the form of a roll, it will have a contacting surface only. The topography of the abrasive article formed by the method of structured abrasives according to the present disclosure will have the inverse of the pattern of the contacting surface of the production tool. The pattern of the contacting surface of the production tool will generally be characterized by a plurality of cavities or recesses. The opening of these cavities can have any shape such as for example, a regular or irregular rectangle, semicircle, circle, triangle, square, hexagon, or octagon. The walls of the cavities can be vertical or tapered. The pattern formed by the cavities can be arranged according to a specified plan or can be random. The cavities can butt up against one another.

Thermoplastic materials that can be used to construct the production tool include polyesters, polycarbonates, poly(ether sulfone), poly(methyl methacrylate), polyurethanes, polyvinylchloride, polyolefins, polystyrene, or combinations thereof. Thermoplastic materials can include additives such as plasticizers, free radical scavengers or stabilizers, thermal stabilizers, antioxidants, and ultraviolet radiation absorbers.

A thermoplastic production tool can be made, for example, according to the following procedure. A master tool is first provided. The master tool is preferably made from metal, e.g., nickel. The master tool can be fabricated by any conventional technique, such as engraving, hobbing, knurling, electroforming, diamond turning, or laser machining The master tool should have the inverse of the pattern desired for the surface of the production tool. The thermoplastic material can be embossed with the master tool to form the pattern. Embossing can be conducted while the thermoplastic material is in a flowable state. After being embossed, the thermoplastic material can be cooled to bring about solidification.

The production tool can also be made of a cured thermosetting resin. A production tool made of thermosetting material can be made according to the following procedure. An uncured thermosetting resin is applied to a master tool of the type described previously. While the uncured resin is on the surface of the master tool, it can be cured or polymerized by heating such that it will set to have the inverse shape of the pattern of the surface of the master tool. Then, the cured thermosetting resin is removed from the surface of the master tool. The production tool can be made of a cured radiation curable resin, such as, for example acrylated urethane oligomers. Radiation cured production tools are made in the same manner as production tools made of thermosetting resin, with the exception that curing is conducted by means of exposure to radiation (e.g., ultraviolet radiation).

The contacting surface of the production tool may also contain a release coating to permit easier release of the abrasive article from the production tool. Examples of such release coatings include silicones and fluorochemicals.

Further details concerning materials and methods for making structured abrasive layers secured to backings can be found in, for example, U.S. Pat. No. 5,435,816 (Spurgeon et al.); U.S. Pat. No. 5,672,097 (Hoopman); U.S. Pat. No. 5,681,217 (Hoopman et al.); U.S. Pat. No. 5,454,844 (Hibbard et al.); U.S. Pat. No. 5,851,247 (Stoetzel et al.); U.S. Pat. No. 6,139,594 (Kincaid et al.); and U.S. Pat. No. 8,251,774 B2 (Joseph et al.).

Various suitable structured abrasives are commercially available, for example, under the trade designation “TRIZACT” from 3M Company, Saint Paul, Minn. Examples include: 3M TRIZACT LAPPING FILM 162XA (46 micron nominal grade, Mohs hardness <3); 3M TRIZACT LAPPING FILM ALUMINUM OXIDE 268XA (available in 5, 10, 20, and 35 micron nominal grades); 3M TRIZACT LAPPING FILM CERIUM OXIDE M-568XA (0.5 micron nominal grade); 3M TRIZACT DIAMOND LAPPING FILM (available in 0.5, 2, and 9 micron diamond nominal grades); 3M TRIZACT DIAMOND TILE 677XA structured abrasive sheets (available in 3, 6, 9, and 20 micron diamond nominal grades). The structured abrasive thus prepared may be then converted into an abrasive belt according to known methods. It may also be secured to the peripheral surface of a support wheel to form an abrasive wheel.

Preferably, the width of the structured abrasive layer is less than or equal to about ⅛th (12.5 percent), less than 1/10th (10 percent), or even less than 1/20th (5 percent) of the diameter of the abrasive article (e.g., in the case of a wheel) and/or the size and shape of the desired recess (e.g., the diameter of a dimple or the width (i.e., width not diameter) of a ring). Typically, the selection of the width of the structured abrasive layer and the diameter of the wheel will be dictated by the specific application, and will be determined by the size of the dimple, and the precision and speed of the abrading process.

### Select Examples of the Present Disclosure

In a first example, the present disclosure provides a method including forming an assembly comprising a substrate and component attached to a first surface of the substrate, where the substrate further comprises a second surface substantially opposite to the first surface. The method also may include frictionally contacting a structured abrasive layer of an abrasive article with the second surface of the substrate. The abrasive article may include a structured abrasive member disposed along a peripheral surface of a support member, and the structured abrasive member comprises the structured abrasive layer comprising shaped abrasive composites secured to a backing. The backing may be proximate to the support member, and the shaped abrasive composites comprise abrasive particles retained in a binder material. The method further may include longitudinally advancing the structured abrasive layer relative to the second surface of the substrate, and rotating the substrate around a rotational axis substantially perpendicular to the second surface of the substrate such that the structured abrasive layer maintains contact with and abrades the second surface of the substrate thereby forming a recess therein.

In a second example, the present disclosure provides a method according to the first example, wherein the method is carried out in the absence of added loose abrasive particles or abrasive slurry.

In a third example, the present disclosure provides a method according to the first example, wherein the recess comprises at least one of a dimple, ellipsoidal recess, an oval recess, a trough, and a ring recess, and wherein the radius of curvature of the recess is substantially consistent in at least one plane substantially perpendicular to the second surface.

In a fourth example, the present disclosure provides a method according to the first example, wherein the substrate has a cylindrical passage extending therethrough perpendicular to the surface of the substrate, and wherein the rotational axis is collinear with the cylindrical passage.

In a fifth example, the present disclosure provides a method according to the first example, wherein the substrate is selected from the group consisting of a glass substrate and a sapphire substrate.

In a sixth example, the present disclosure provides a method according to the first example, wherein the component is selected from the group consisting of an electronic module, a component of a display, a biometric sensor, a biomedical sensor, a speaker, a microphone, a haptic device, a presence-sensitive sensor, and combinations thereof.

In seventh example, the disclosure describes a method including forming a treated substrate comprising a modified surface, and frictionally contacting a structured abrasive layer of an abrasive article with the modified surface of the substrate. The abrasive article may include a structured abrasive member disposed along a peripheral surface of a support member, and the structured abrasive member comprises the structured abrasive layer comprising shaped abrasive composites secured to a backing. The backing may be proximate to the support member, and the shaped abrasive composites comprise abrasive particles retained in a binder material. The method further may include longitudinally advancing the structured abrasive layer relative to the modified surface of the substrate, and rotating the substrate around a rotational axis substantially perpendicular to the modified surface of the substrate such that the structured abrasive layer maintains contact with and abrades the modified surface of the substrate thereby forming a recess therein.

In an eighth example, the present disclosure provides a method according to the seventh example, wherein forming the treated substrate comprises coating or laminating a film to a substrate to form the modified surface.

In a ninth example, the present disclosure provides a method according to the seventh example, wherein forming the treated glass substrate comprises ion-exchange treating a surface of a glass substrate to form the modified surface.

In a tenth example, the present disclosure provides a method according to the seventh example, wherein the treated substrate is selected from the group consisting of a treated glass substrate and a treated sapphire substrate.

In an eleventh example, the present disclosure provides a method according to the seventh example, wherein the method is carried out in the absence of added loose abrasive particles or abrasive slurry.

In a twelfth example, the disclosure describes an article including a substrate comprising a surface defining a recess. According to this example, the recess has a substantially consistent radius of curvature in at least one plane substantially perpendicular to the surface for at least about 98% of a depth of the recess, and the depth of the recess is measured from the plane of the surface to a point of the recess furthest from the surface in a direction substantially normal to the plane of the surface.

In a thirteenth example, the disclosure describes an article according to the twelfth example, wherein edge roll off from the recess to the surface of the substrate is confined to less than about 2% of the depth of the recess.

In a fourteenth example, the disclosure describes an article according to the twelfth example, wherein the substrate comprises at least one of glass or sapphire.

In a fifteenth example, the disclosure describes an article according to the twelfth example, wherein the article comprises an electronic device including a housing and display, and wherein the substrate comprises a portion of the housing facing an opposite direction to the display.

In a sixteenth example, the disclosure describes an article according to the twelfth example, wherein the surface defines a plurality of recesses, and wherein the recesses are located at positions of the surface selected such that a respective fingers of a user will rest at or near respective recesses of the plurality of recesses when the user is holding the electronic device in a selected orientation.

In a seventeenth example, the disclosure describes an article according to the twelfth example, wherein the article comprises an electronic device including a display, and wherein the substrate comprises a cover sheet of the display.

In an eighteenth example, the disclosure describes an article according to the twelfth example, further comprising a component selected from the group consisting of an electronic module, a component of a display, a biometric sensor, a biomedical sensor, a speaker, a microphone, a haptic device, a presence-sensitive sensor, and combinations thereof, wherein the component is attached to the substrate.

In a nineteenth example, the disclosure describes an article according to the eighteenth example, wherein the surface comprises a first surface, wherein substrate further comprises a second surface substantially opposite to the first surface, and wherein the component is attached to the second surface proximate to the recess.

In a twentieth example, the disclosure describes an article according to the eighteenth example, wherein the component is at least partially disposed within a volume defined by the recess.

In a twenty-first example, the disclosure describes an article according to the twelfth example, wherein the surface comprises a first surface, wherein substrate further comprises a second surface substantially opposite to the first surface, the article further comprising a cylindrical passage extending between the recess and the second surface.

In a twenty-second example, the disclosure describes an article according to the twenty-first example, further comprising a component disposed at least partially within the cylindrical passage, wherein the component is selected from the group consisting of a pressure sensor, a microphone, a speaker, an electrical conductor, and combinations thereof.

In a twenty-third example, the disclosure describes an article according to the twenty-first example, further comprising a flexible membrane covering the recess and attached to the first surface, and liquid disposed in the recess and the cylindrical passage, and wherein the component comprises a reservoir.

In a twenty-fourth example, the disclosure describes an article according to the twelfth example, wherein the recess comprises at least one of a dimple, an ellipsoidal recess, an oval recess, a trough and a ring recess.

In a twenty-fifth example, the disclosure describes an assembly that includes a substrate comprising a recess and a component located adjacent to the recess and attached to the substrate. The recess is formed by frictionally contacting a structured abrasive layer of an abrasive article with a surface of the substrate, longitudinally advancing the structured abrasive layer relative to the surface of the substrate, and rotating the substrate around a rotational axis substantially perpendicular to the surface of the substrate such that the structured abrasive layer maintains contact with and abrades the surface of the substrate thereby forming the recess therein. The abrasive article may include a structured abrasive member disposed along a peripheral surface of a support member, and the structured abrasive member comprises the structured abrasive layer comprising shaped abrasive composites secured to a backing. The backing may be proximate to the support member, and the shaped abrasive composites comprise abrasive particles retained in a binder material.

In a twenty-sixth example, the present disclosure provides a method according to the twenty-fifth example, wherein the component is disposed at least partially within a volume defined by the recess.

In a twenty-seventh example, the present disclosure provides a method according to the twenty-fifth example, wherein the component is selected from the group consisting of an electronic module, a component of a display, a biometric sensor, a biomedical sensor, a speaker, a microphone, a haptic device, a presence-sensitive sensor, and combinations thereof.

In a twenty-eighth example, the present disclosure provides a method according to the twenty-fifth example, wherein the recess is formed in a first surface of the substrate, and wherein the component is located adjacent to a second surface substantially opposite to the first surface.

In a twenty-ninth example, the present disclosure provides a method according to the twenty-fifth example, wherein the recess comprises at least one of a dimple, an ellipsoidal recess, an oval recess, a trough and a ring recess.

### EXAMPLES

Unless otherwise noted, all parts, percentages, ratios, etc. in the Examples and the rest of the specification are by weight.

### Test Methods

### Profilometry

Contact profilometry was conducted using a P16+ stylus profiler, available from KLA-Tencor Corporation, Milpitas Calif. The scan length was 8.0 mm and the scan rate was 100 μm/s. The load on the stylus was 0.5 mg and the stylus tip radius was 0.15 μm. Contact profilometry was performed on a dimple with a surface described as a portion of a sphere, formed using techniques described in this disclosure. The dimple had a substantially consistent (e.g., consistent or nearly consistent) radius of curvature (ROC) for at least 98% of the depth of the feature (where the depth of the recess is measured from the lowest point of the recess to a the plane of the surface of the substrate in which the recess is formed, and is in a direction substantially normal to the plane of the surface of the substrate). The edge shape of the recess is sharp and edge roll off was less than about 2% of the total depth of the recess (e.g., between about 0.1% and 2% of the depth of the recess). In comparison, slurry abrasion processes result in varying ROC (primarily at the edge) and edge roll off of 10-20% of the depth of the recess, depending on the process.

### Example 1

This example describes the preparation of an abrasive wheel according to the present disclosure. A sheet of 3M TRIZACT 568XA ceria abrasive, available from the 3M Company, St. Paul, Minn., was cut into a strip 0.045 inch (0.11 cm) wide and 12 inches (30.5 cm) long. 3M SCOTCH-WELD instant adhesive, available from the 3M Company was applied to the back side of an end of the abrasive strip, covering about 0.5 inch (1.3 cm) length of the strip. The back side of the abrasive strip with adhesive was brought into contact with the outer peripheral surface of an 88 mm diameter×0.1 in (0.25 cm) thick metal support member having an integral central shaft. The adhesive was allowed to cure. Additional adhesive was applied to the backside of the abrasive strip in about 0.5 inch (1.3 cm) lengths. The adhesive with abrasive was brought into contact with the outer peripheral surface of the support member. This process was continued until the entire peripheral surface of the support member was covered with abrasive. Before securing the last section of the abrasive surface to the peripheral surface, the abrasive strip was cut to the appropriate length, so that the last section of the abrasive strip did not overlap with the first section of the abrasive strip attached to support member. The adhesive was allowed to cure, producing an abrasive wheel.

### Example 2

This example describes a single-step lapping method for fabricating a dimple according to the present disclosure. The abrasive wheel produced in Example 1 was mounted in the chuck of a rotatable drive such that the major surfaces of the wheel were parallel to the ground. A soda-lime glass plate, 2 in (5.1 cm)×3 in (7.6 cm)×0.12 cm was mounted on the rotatable fixture of a FIBERMET optical fiber polisher, model #69-3000-160, available from Buehler, Lake Bluff, Ill. Prior to mounting the glass plate to the fixture, a rubber sheet, about 2 in (5.1 cm)×3 in (7.6 cm)×1 mm was mounted on the face of the fixture using double side adhesive tape. The glass plate was mounted to the rubber sheet using double sided adhesive tape. The major surface of the fixture (i.e., the surface the glass plate was mounted to) was perpendicular to the ground. The polisher was mounted on a programmable x-y stage, such that it could traverse. The stage with polisher was positioned adjacent to the abrasive wheel, such that, the peripheral surface of the abrasive wheel could contact the center axis of the rotatable fixture of the polisher. The abrasive wheel was rotated at 1,000 rpm and the glass plate was rotated at 150 rpm. The polisher was traversed, via the x-y stage, such that, the rotational axis of the mounted glass plate contacted the leading edge of the rotating abrasive wheel. Prior to contact, a coolant, water at 8 ml/min, was flowed onto the edge of the rotating wheel directly adjacent to the glass plate. The polisher was continuously traversed into the edge of the abrasive wheel at a rate of 12 μm/min. Traversing of the polisher was continued for 4 minutes, at which time the polisher was left in a stationary position and lapping was continued for an additional 30 seconds. At this time, rotation of both the glass plate and abrasive wheel was stopped. The glass was removed from the polisher. A profilometer scan, per the above test method, was conducted across the lapped region of the glass plate and the glass plate was observed to have a hemispherical recess of about 48 μm in depth with a diameter of about 4.5 mm.

### Example 3

This example describes the preparation of an abrasive wheel according to the present disclosure. An abrasive wheel was prepared using the same procedure as Example 1, except that the 3M TRIZACT 568XA ceria abrasive sheet was replaced with a sheet of 3M TRIZACT DIAMOND TILE 677XA 20 μm abrasive, available from the 3M Company, and the abrasive sheet was cut into a strip 0.100 in (0.25 cm) wide and 12 inches (30.5 cm) long, producing an abrasive wheel.

### Example 4

This example describes the preparation of an abrasive wheel according to the present disclosure. An abrasive wheel was prepared using the same procedure as Example 1, except that the 3M TRIZACT 568XA ceria abrasive was cut into a strip 0.075 in (0.19 cm) wide and 12 inches (30.5 cm) long, producing an abrasive wheel.

### Example 5

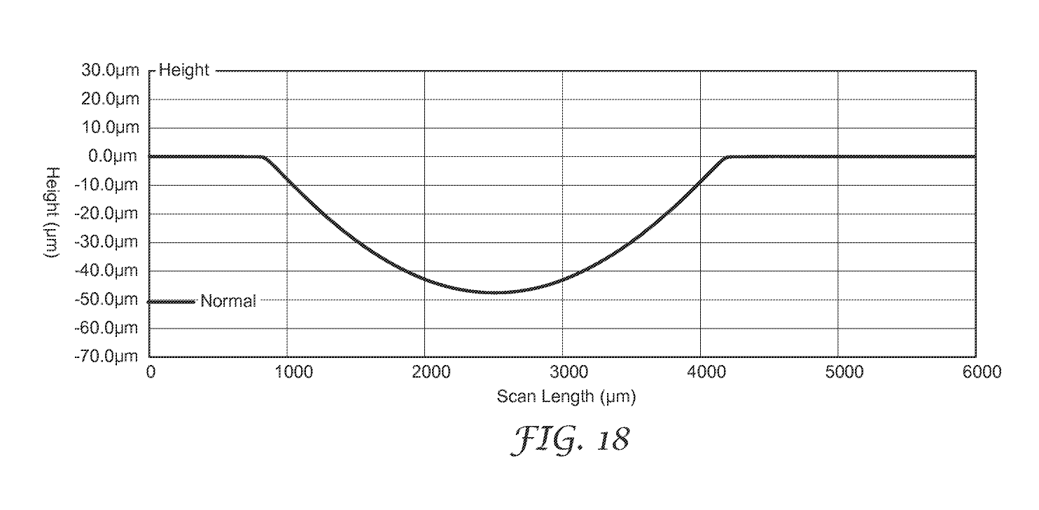

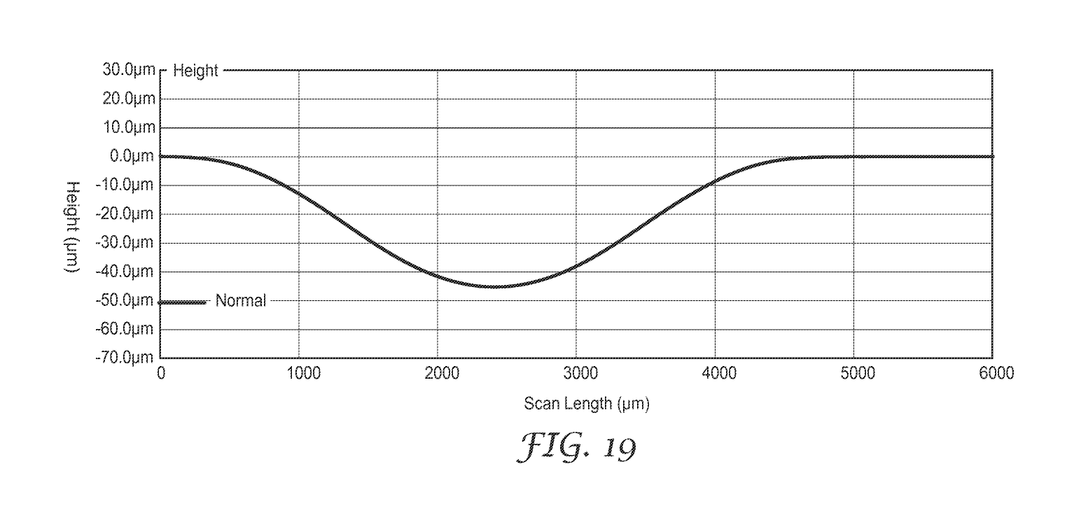

This example describes a two-step lapping method for fabricating a dimple according to the present disclosure. The equipment, equipment configuration, and general lapping procedure described in Example 2 was used for the two-step lapping process. The abrasive wheel produced in Example 3 was mounted in the chuck of the rotatable drive. A soda-lime glass plate, 2 in (5.1 cm)×3 in (7.6 cm)×0.12 cm was mounted on the rotatable fixture of the polisher. The abrasive wheel was rotated at 2,000 rpm and the glass plate was rotated at 150 rpm. Water flowing at 20 ml/min was again used as coolant. The stage with polisher was continuously traversed into the edge of the abrasive wheel at a rate of 1.25 mm/min for 15 seconds, at which time the polisher was left in a stationary position and lapping was continued for an additional 5 seconds. The glass plate was removed from contacting the abrasive wheel via the stage and rotation of both the glass plate and abrasive wheel was stopped. The abrasive wheel was removed from the chuck and the abrasive wheel produced in Example 4 was mounted in the chuck. The abrasive wheel was rotated at 1,000 rpm and the glass plate was rotated at 150 rpm. Water flowing at 8 ml/min was again used as coolant. The stage with polisher was continuously traversed into the edge of the abrasive wheel at a rate of 25 μm/min for 2 minutes, at which time the polisher was left in a stationary position and lapping was continued for an additional 30 seconds. The glass was removed from the polisher. A profilometer scan (shown in FIG. 18), per the above test method, was conducted across the lapped region of the glass plate and the glass plate was observed to have a hemispherical recess of about 340 μm in depth with a diameter of about 11 mm. The radius of curvature of the hemispherical recess was substantially equal to the radius of the abrasive wheel.

### Comparative Example A

This example describes the preparation of a non-abrasive wheel according to the present disclosure. A non-abrasive wheel was prepared using the same procedure as Example 1, except that the 3M TRIZACT 568XA ceria abrasive sheet was replaced with a sheet of 3M POLISHING FILM 968M (non-abrasive material), available from the 3M Company, producing a non-abrasive wheel (i.e., covered with an abrasive-free polishing pad).

### Comparative Example B

This example describes a method for fabricating a dimple using a non-abrasive wheel in conjunction with abrasive slurry. The equipment, equipment configuration, and general lapping procedure described in Example 1 were used for the slurry process. The non-abrasive wheel of Comparative Example A was mounted in the chuck of the rotatable drive. A soda-lime glass plate, 2 in (5.1 cm)×3 in (7.6 cm)×0.12 cm was mounted on the rotatable fixture of the polisher. The non-abrasive wheel was rotated at 1,000 rpm and the glass plate was rotated at 120 rpm. Slurry was flowed to the non-abrasive wheel/glass interface during the process. The slurry was a 10 wt. % mixture of 0.5 μm cerium oxide in deionized water. The stage with polisher was continuously traversed into the edge of the abrasive wheel at a rate of 25 μm/min for 3 minutes, at which time the polisher was left in a stationary position and lapping was continued for an additional 30 seconds. The glass was removed from the polisher. A profilometer scan, per the above test method, was conducted across the lapped region of the glass plate and the glass plate was observed to have a hemispherical recess of about 45 μm in depth and a diameter of about 5.5 mm.

Comparing the results of Example 2 (see FIG. 18) to those of Comparative Example B (See FIG. 19), the lapping process using the abrasive pad wheel produced a recess having sharper edge topography and a smaller diameter than that produced by a process employing a non-abrasive pad in conjunction with cerium oxide slurry.

Other than in the Background section, all cited references, patents, or patent applications, in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A method comprising:
forming an assembly comprising a substrate and component attached to a first surface of the substrate, wherein the substrate further comprises a second surface substantially opposite to the first surface;
frictionally contacting a structured abrasive layer of an abrasive article with the second surface of the substrate, wherein the abrasive article comprises a structured abrasive member disposed along a peripheral surface of a support member, wherein the structured abrasive member comprises the structured abrasive layer comprising shaped abrasive composites secured to a backing, wherein the backing is proximate to the support member, and wherein the shaped abrasive composites comprise abrasive particles retained in a binder material;
longitudinally advancing the structured abrasive layer relative to the second surface of the substrate; and
rotating the substrate around a rotational axis substantially perpendicular to the second surface of the substrate such that the structured abrasive layer maintains contact with and abrades the second surface of the substrate thereby forming a recess therein.

2. The method of claim 1, wherein the method is carried out in the absence of added loose abrasive particles or abrasive slurry.

3. The method of claim 1, wherein the recess comprises at least one of a dimple, ellipsoidal recess, an oval recess, a trough, and a ring recess, and wherein the radius of curvature of the recess is substantially consistent in at least one plane substantially perpendicular to the second surface.

4-6. (canceled)

7. A method comprising:
forming a treated substrate comprising a modified surface;
frictionally contacting a structured abrasive layer of an abrasive article with the modified surface of the substrate, wherein the abrasive article comprises a structured abrasive member disposed along a peripheral surface of a support member, wherein the structured abrasive member comprises the structured abrasive layer comprising shaped abrasive composites secured to a backing, wherein the backing is proximate to the support member, and wherein the shaped abrasive composites comprise abrasive particles retained in a binder material;
longitudinally advancing the structured abrasive layer relative to the modified surface of the substrate; and
rotating the substrate around a rotational axis substantially perpendicular to the modified surface of the substrate such that the structured abrasive layer maintains contact with and abrades the modified surface of the substrate thereby forming a recess therein.

8-10. (canceled)

11. The method of claim 7, wherein the method is carried out in the absence of added loose abrasive particles or abrasive slurry.

12. An article comprising:
a substrate comprising a surface defining a recess, wherein the recess has a substantially consistent radius of curvature in at least one plane substantially perpendicular to the surface for at least about 98% of a depth of the recess, wherein the depth of the recess is measured from the plane of the surface to a point of the recess furthest from the surface in a direction substantially normal to the plane of the surface.

13. The article of claim 12, wherein edge roll off from the recess to the surface of the substrate is confined to less than about 2% of the depth of the recess.

14. The article of claim 12, wherein the substrate comprises at least one of glass or sapphire.

15. The article of claim 12, wherein the article comprises an electronic device including a housing and display, and wherein the substrate comprises a portion of the housing facing an opposite direction to the display.

16. (canceled)

17. The article of claim 12, wherein the article comprises an electronic device including a display, and wherein the substrate comprises a cover sheet of the display.

18. The article of claim 12, further comprising a component selected from the group consisting of an electronic module, a component of a display, a biometric sensor, a biomedical sensor, a speaker, a microphone, a haptic device, a presence-sensitive sensor, and combinations thereof, wherein the component is attached to the substrate.

19. (canceled)

20. The article of claim 18, wherein the component is at least partially disposed within a volume defined by the recess.

21. The article of claim 12, wherein the surface comprises a first surface, wherein substrate further comprises a second surface substantially opposite to the first surface, the article further comprising a cylindrical passage extending between the recess and the second surface.

22. (canceled)

23. The article of claim 21, further comprising a flexible membrane covering the recess and attached to the first surface, and liquid disposed in the recess and the cylindrical passage, and wherein the component comprises a reservoir.

24. The article of claim 12, wherein the recess comprises at least one of a dimple, an ellipsoidal recess, an oval recess, a trough and a ring recess.

25. An assembly comprising:
a substrate comprising a recess, wherein the recess is formed by:
frictionally contacting a structured abrasive layer of an abrasive article with a surface of the substrate, wherein the abrasive article comprises a structured abrasive member disposed along a peripheral surface of a support member, wherein the structured abrasive member comprises the structured abrasive layer comprising shaped abrasive composites secured to a backing, wherein the backing is proximate to the support member, and wherein the shaped abrasive composites comprise abrasive particles retained in a binder material;
longitudinally advancing the structured abrasive layer relative to the surface of the substrate; and
rotating the substrate around a rotational axis substantially perpendicular to the surface of the substrate such that the structured abrasive layer maintains contact with and abrades the surface of the substrate thereby forming the recess therein; and
a component located adjacent to the recess and attached to the substrate.

26. The assembly of claim 25, wherein the component is disposed at least partially within a volume defined by the recess.

27. The assembly of claim 25, wherein the component is selected from the group consisting of an electronic module, a component of a display, a biometric sensor, a biomedical sensor, a speaker, a microphone, a haptic device, a presence-sensitive sensor, and combinations thereof.

28. The assembly of claim 25, wherein the recess is formed in a first surface of the substrate, and wherein the component is located adjacent to a second surface substantially opposite to the first surface.

29. The assembly of claim 25, wherein the recess comprises at least one of a dimple, an ellipsoidal recess, an oval recess, a trough and a ring recess.
